(19) United States
(12) Patent Application Publication
(10) Pub. No.: US 2011/0176614 A1
(43) Pub. Date: Jul. 21, 2011

(54) IMAGE PROCESSING DEVICE AND METHOD, AND PROGRAM

(76) Inventors: Kazushi Sato, Kanagawa (JP); Yoichi Yagasaki, Tokyo (JP)

(21) Appl. No.: 13/001,392

(22) PCT Filed: Jul. 1, 2009
(86) PCT No.: PCT/JP2009/062028

§ 371 Date: Mar. 30, 2011

(30) Foreign Application Priority Data
Jul. 1, 2008 (JP) 2008-172271
Mar. 6, 2009 (JP) 2009-054076

(51) Int. Cl. H04N 7/12

(52) U.S. Cl. 375/240.16; 375/E07.243

(57) ABSTRACT

The present invention relates to an image processing device and method, and program, wherein compression efficiency can be improved.

With regard to a luminance block A_{Y} of 4×4 pixels, motion prediction and compensation processing is performed on the luminance signals using a template region B_{Y} which is configured of decoded pixels and is adjacent to the block A_{Y}, thereby obtaining motion vector information V_{Y}. a color difference TP motion prediction/compensation unit performs motion prediction on a 2×2 pixel color difference block A_{C} regarding color difference signals Cb and Cr, using a template region B_{C} which is configured of decoded pixels and is adjacent to a luminance block A_{C}, with a range E, centered on motion vector information V_{Y}′ obtained by scaling the motion vector information V_{Y}, as the range of searching. The present invention can be applied to an image encoding device which performs encoding with the H.264/AVC format, for example.

### TECHNICAL FIELD

The present invention relates to an image processing device and method, and program, and particularly relates to an image processing device and method, and program, wherein deterioration of compression efficiency is suppressed.

### BACKGROUND ART

In recent years, technology has become commonplace in which images are subjected to compression encoding with formats such as MPEG (Moving Picture Experts Group) 2, H.264 and MPEG-4 Part 10 (Advanced Video Coding) (hereinafter referred to as H.264/AVC), and so forth, packetizing and transmitting, and decoding at a receiving side, have become commonplace. Accordingly, users can view high-quality moving images.

Now, with the MPEG2 format, half-pixel precision motion prediction/compensation is performed by linear interpolation processing, but with the H.264/AVC format, quarter-pixel precision motion prediction/compensation is performed using 6-tap FIR (Finite Impulse Response Filter).

Also, with the MPEG2 format, in the case of frame motion compensation mode, motion prediction/compensation processing is performed in 16×16 pixel increments, and in the case of field motion compensation mode, motion prediction/compensation processing is performed in 16×8 pixel increments for each of a first field and a second field.

On the other hand, with the H.264/AVC format, motion prediction/compensation processing can be performed with variable block sizes. That is to say, with the H.264/AVC format, a macro block configured of 16×16 pixels can be divided into partitions of any one of 16×16, 16×8, 8×16, or 8×8, with each having independent motion vector information. Also, a partition of 8×8 can be divided into sub-partitions of any one of 8×8, 8×4, 4×8, or 4×4, with each having independent motion vector information.

However, with the H.264/AVC format, motion prediction/compensation processing is performed with quarter-pixel precision and variable blocks as described above, resulting in massive motion vector information, leading to deterioration in encoding efficiency if this is encoded as it is.

Accordingly, a method has been proposed wherein a an image region, which is adjacent to an image region to be encoded in a predetermined positional relation and also has high correlation with a decoded image of a template region which is a part of a decoded image, is searched from a decoded image, and prediction is performed based on the positional relation with the searched image (see PTL 1).

This method uses a decoded image for matching, so the same processing can be performed at an encoding device and decoding device by predetermining a search range. That is to say, deterioration in encoding efficiency can be suppressed by performing the above-described motion prediction/compensation processing at the decoding device as well, since there is no need to have motion vector information in image compression information from the encoding device.

### CITATION LIST

### Patent Literature

PTL 1: Japanese Unexamined Patent Application Publication No. 2007-43651

### SUMMARY OF INVENTION

### Technical Problem

However, with the technique in PTL 1, in the event that motion vector information obtained with regard to the luminance component is applied to the color difference component, the prediction capability regarding the color difference component (residual) deteriorates, resulting in deterioration in encoding efficiency even though there is no need to have motion vectors.

The present invention has been made in light of this situation, and to is an object thereof to suppress deterioration in compression efficiency.

### Solution to Problem

An image processing device according to a first aspect of the present invention includes: luminance motion prediction compensation means to search for a motion vector of a luminance block, which is a block of luminance signals of a frame, using a first template which is adjacent to the luminance block with a predetermined positional relation and also is generated from a decoded image; color difference motion prediction compensation means to obtain a search range using information of the motion vector of the luminance block searched by the luminance motion prediction compensation means, and to, within the search range that has been obtained, search for a motion vector of a color difference block which is a block of color difference signals of the frame, corresponding to the luminance block, using a second template which is adjacent to the color difference block with a predetermined positional relation and also is generated from the decoded image; and encoding means to encode an image of the luminance block and the color difference block.

The color difference motion prediction compensation means may perform scaling of information of the motion vector of the luminance block searched by the luminance motion prediction compensation means, in accordance with a chroma format of input image signals, and obtain the search range centered on information of the motion vector of the luminance block that has been scaled.

In the event that the luminance block and the color difference block are in a one-on-one correlating relation, information of the motion vector of the luminance block is (MVTMₕ, MVTMᵥ) and rₕ and rᵥ are defined as

$$[ Mathematical Expression 1 ]$$

$${r}_{h} = \{ \begin{matrix}2 ( Case of 4 \text{:} 2 \text{:} 0 ) \\ 2 ( Case of 4 \text{:} 2 \text{:} 2 ) \\ 1 ( Case of 4 \text{:} 4 \text{:} 4 )\end{matrix} \\ {r}_{v} = \{ \begin{matrix}2 ( Case of 4 \text{:} 2 \text{:} 0 ) \\ 1 ( Case of 4 \text{:} 2 \text{:} 2 ) \\ 1 ( Case of 4 \text{:} 4 \text{:} 4 )\end{matrix}$$

the color difference motion prediction compensation means may obtain the search range centered on (MVTMₕ/rₕ, MVTMᵥ/rᵥ).

In the event that a single the color difference block corresponds to a plurality of the luminance blocks, the color difference motion prediction compensation means may synthesize information of motion vectors of a plurality of the luminance blocks, perform scaling in accordance with the chroma format, and obtain the search range centered on information of the motion vector of the luminance block that has been scaled.

The color difference motion prediction compensation means may perform synthesizing using the average value of the information of motion vectors of the plurality of the luminance blocks.

The color difference motion prediction compensation means may obtain the search range regarding only a reference frame of the luminance block, and search for a motion vector of the color difference block in the search range that has been obtained, using the second template.

The color difference motion prediction compensation means may obtain the search range regarding only a reference frame having, of reference frames of the luminance block, a smallest index, and search for a motion vector of the color difference block in the search range that has been obtained, using the second template.

The size of the luminance block and the color difference block differ, and the size of the first template and the size of the second template differ.

The image processing device may further include orthogonal transform control means to forbid, in the event that a motion prediction regarding which motion prediction is to be performed is the color difference block and is not a macro block, orthogonal transform as to a direct current component of the motion prediction block.

An image processing method according to the first aspect of the present invention includes the steps of an image processing device searching for a motion vector of a luminance block, which is a block of luminance signals of a frame, using a first template which is adjacent to the luminance block with a predetermined positional relation and also is generated from a decoded image; obtaining a search range using information of the motion vector of the luminance block searched by the luminance motion prediction compensation means, and, within the search range that has been obtained, searching for a motion vector of a color difference block which is a block of color difference signals of the frame, corresponding to the luminance block, using a second template which is adjacent to the color difference block with a predetermined positional relation and also is generated from the decoded image; and encoding an image of the luminance block and the color difference block.

An image processing device according to a second aspect of the present invention includes: decoding means to decode an image, which is a luminance block which is a block of luminance signals and a color difference block which is a block of color difference signals and which corresponds to the luminance block, of an encoded frame; luminance motion prediction compensation means to search for a motion vector of the luminance block, using a first template which is adjacent to the luminance block with a predetermined positional relation and also is generated from a decoded image; and color difference motion prediction compensation means to obtain a search range using information of the motion vector of the luminance block searched by the luminance motion prediction compensation means, and to, within the search range that has been obtained, search for a motion vector of the color difference block, using a second template which is adjacent to the color difference block with a predetermined positional relation and also is generated from the decoded image.

The color difference motion prediction compensation means may perform scaling of information of the motion vector of the luminance block searched by the luminance motion prediction compensation means, in accordance with a chroma format of input image signals, and obtain the search range centered on information of the motion vector of the luminance block that has been scaled.

In the event that the luminance block and the color difference block are in a one-on-one correlating relation, information of the motion vector of the luminance block is (MVTMₕ, MVTMᵥ) and rₕ and rᵥ are defined as

$$[ Mathematical Expression 2 ]$$

$${r}_{h} = \{ \begin{matrix}2 ( Case of 4 \text{:} 2 \text{:} 0 ) \\ 2 ( Case of 4 \text{:} 2 \text{:} 2 ) \\ 1 ( Case of 4 \text{:} 4 \text{:} 4 )\end{matrix} \\ {r}_{v} = \{ \begin{matrix}2 ( Case of 4 \text{:} 2 \text{:} 0 ) \\ 1 ( Case of 4 \text{:} 2 \text{:} 2 ) \\ 1 ( Case of 4 \text{:} 4 \text{:} 4 )\end{matrix}$$

the color difference motion prediction compensation means may obtain the search range centered on (MVTMₕ/rₕ, MVTMᵥ/rᵥ).

In the event that a single the color difference block corresponds to a plurality of the luminance blocks, the color difference motion prediction compensation means may synthesize information of motion vectors of a plurality of the luminance blocks, perform scaling in accordance with the chroma format, and obtain the search range centered on information of the motion vector of the luminance block that has been scaled.

The color difference motion prediction compensation means may perform synthesizing using the average value of the information of motion vectors of the plurality of the luminance blocks.

The color difference motion prediction compensation means may obtain the search range regarding only a reference frame of the luminance block, and search for a motion vector of the color difference block in the search range that has been obtained, using the second template.

The color difference motion prediction compensation means may obtain the search range regarding only a reference frame having, of reference frames of the luminance block, a smallest index, and search for a motion vector of the color difference block in the search range that has been obtained, using the second template.

The size of the luminance block and the color difference block differ, and the size of the first template and the size of the second template differ.

The image processing device may further include orthogonal transform control means to forbid, in the event that a motion prediction regarding which motion prediction is to be performed is the color difference block and is not a macro block, orthogonal transform as to a direct current component of the motion prediction block.

An image processing method according to the second aspect of the present invention includes the steps of an image processing device decoding an image, which is a luminance block which is a block of luminance signals and a color difference block which is a block of color difference signals and which corresponds to the luminance block, of an encoded frame; searching for a motion vector of the luminance block, using a first template which is adjacent to the luminance block with a predetermined positional relation and also is generated from a decoded image; and obtaining a search range using information of the motion vector of the luminance block searched by the luminance motion prediction compensation means, and, within the search range that has been obtained, searching for a motion vector of the color difference block, using a second template which is adjacent to the color difference block with a predetermined positional relation and also is generated from the decoded image.

According to the first aspect of the present invention, a motion vector of a luminance block, which is a block of luminance signals of a frame, is searched for using a first template which is adjacent to the luminance block with a predetermined positional relation and also is generated from a decoded image; a search range is obtained using information of the motion vector of the luminance block searched by the luminance motion prediction compensation means, and, within the search range that has been obtained, a motion vector of a color difference block which is a block of color difference signals of the frame, corresponding to the luminance block, is searched for using a second template which is adjacent to the color difference block with a predetermined positional relation and also is generated from the decoded image. An image of the luminance block and the color difference block is then encoded.

According to the second aspect of the present invention, an image, which is a luminance block which is a block of luminance signals and a color difference block which is a block of color difference signals and which corresponds to the luminance block, of an encoded frame, is decoded; a motion vector of the luminance block is searched for, using a first template which is adjacent to the luminance block with a predetermined positional relation and also is generated from a decoded image; and a search range is obtained using information of the motion vector of the luminance block searched by the luminance motion prediction compensation means, and, within the search range that has been obtained, a motion vector of the color difference block is searched for, using a second template which is adjacent to the color difference block with a predetermined positional relation and also is generated from the decoded image.

### Advantageous Effects of Invention

As described above, according to the first aspect of the present invention, an image can be encoded. Also, according to the first aspect of the present invention, deterioration in compression efficiency can be suppressed.

As described above, according to the second aspect of the present invention, an image can be decoded. Also, according to the second aspect of the present invention, deterioration in compression efficiency can be suppressed.

### BRIEF DESCRIPTION OF DRAWINGS

FIG. 1 is a block diagram illustrating an embodiment of an image encoding device to which the present invention has been applied.

FIG. 2 is a diagram describing variable block size motion prediction/compensation processing.

FIG. 3 is a diagram describing quarter-pixel precision motion prediction/compensation processing.

FIG. 4 is a flowchart describing encoding processing of the image encoding device in FIG. 1.

FIG. 5 is a flowchart describing the prediction processing of step S21 in FIG. 4.

FIG. 6 is a diagram describing the order of processing in the case of a 16×16 pixel intra prediction mode.

FIG. 7 is a diagram illustrating the types of 4×4 pixel intra prediction modes for luminance signals.

FIG. 8 is a diagram illustrating the types of 4×4 pixel intra prediction modes for luminance signals.

FIG. 9 is a diagram describing the directions of 4×4 pixel intra prediction.

FIG. 10 is a diagram describing 4×4 pixel intra prediction.

FIG. 11 is a diagram describing encoding with 4×4 pixel intra prediction modes for luminance signals.

FIG. 12 is a diagram illustrating the types of 8×8 pixel intra prediction modes for luminance signals.

FIG. 13 is a diagram illustrating the types of 8×8 pixel intra prediction modes for luminance signals.

FIG. 14 is a diagram illustrating the types of 16×16 pixel intra prediction modes for luminance signals.

FIG. 15 is a diagram illustrating the types of 16×16 pixel intra prediction modes for luminance signals.

FIG. 16 is a diagram describing 16×16 pixel intra prediction.

FIG. 17 is a diagram illustrating the types of pixel intra prediction modes for color difference signals.

FIG. 18 is a flowchart describing the intra prediction processing of step S31 in FIG. 5.

FIG. 19 is a flowchart describing the inter motion prediction processing of step S32 in FIG. 5.

FIG. 20 is a flowchart describing a method for generation motion vector information.

FIG. 21 is a flowchart describing the inter template motion prediction processing of step S33 in FIG. 5.

FIG. 22 is a diagram describing the intra template matching method.

FIG. 23 is a diagram describing an example of motion prediction/compensation processing for color difference signals in the intra template prediction mode.

FIG. 24 is a diagram describing another example of motion prediction/compensation processing for color difference signals in the intra template prediction mode.

FIG. 25 is a flowchart describing the intra template motion prediction processing in step S35 of FIG. 5.

FIG. 26 is a diagram describing the intra template matching method.

FIG. 27 is a diagram describing multi-reference frame motion prediction/compensation processing method.

FIG. 28 is a block diagram illustrating an embodiment of an image decoding device to which the present invention has been applied.

FIG. 29 is a flowchart describing decoding processing of an image decoding device shown in FIG. 28.

FIG. 30 is a flowchart describing the prediction processing in step S138 in FIG. 29.

FIG. 31 is a block diagram illustrating another embodiment of an image encoding device to which the present invention has been applied.

FIG. 32 is a block diagram illustrating a configuration example of an orthogonal transform control unit.

FIG. 33 is a flowchart describing orthogonal transform control processing of the image encoding device in FIG. 31.

FIG. 34 is a block diagram illustrating another embodiment of an image decoding device to which the present invention has been applied.

FIG. 35 is a flowchart describing orthogonal transform control processing of the image decoding device in FIG. 34.

### DESCRIPTION OF EMBODIMENTS

Embodiments of the present invention will be described with reference to the drawings.

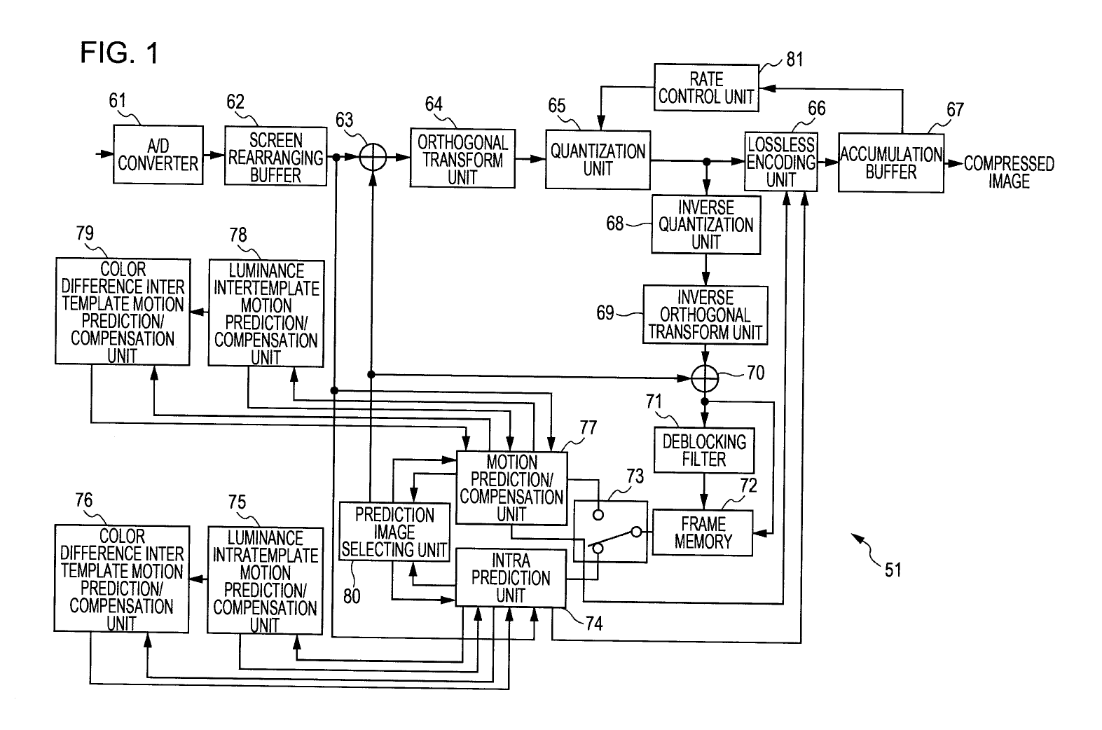

FIG. 1 illustrates the configuration of an embodiment of an image encoding device serving as an image processing device to which the present invention has been applied. This image encoding device 51 includes an A/D converter 61, a screen rearranging buffer 62, a computing unit 63, an orthogonal transform unit 64, a quantization unit 65, a lossless encoding unit 66, an accumulation buffer 67, an inverse quantization unit 68, an inverse orthogonal transform unit 69, a computing unit 70, a deblocking filter 71, a frame memory 72, a switch 73, an intra prediction unit 74, a luminance intra template motion prediction/compensation unit 75, a color difference intra template motion prediction/compensation unit 76, a motion prediction/compensation unit 77, a luminance inter template motion prediction/compensation unit 78, a color difference inter template motion prediction/compensation unit 79, a prediction image selecting unit 80, and a rate control unit 81.

Note that in the following, the luminance intra template motion prediction/compensation unit 75 and the color difference intra template motion prediction/compensation unit 76 will each be called luminance intra TP motion prediction/compensation unit 75 and color difference intra TP motion prediction/compensation unit 76. Also, the luminance inter template motion prediction/compensation unit 78 and the color difference inter template motion prediction/compensation unit 79 will each be called luminance inter TP motion prediction/compensation unit 78 and color difference inter TP motion prediction/compensation unit 79.

This image encoding device 51 performs compression encoding of images with H.264 and MPEG-4 Part 10 (Advanced Video Coding) (hereinafter referred to as H.264/AVC).

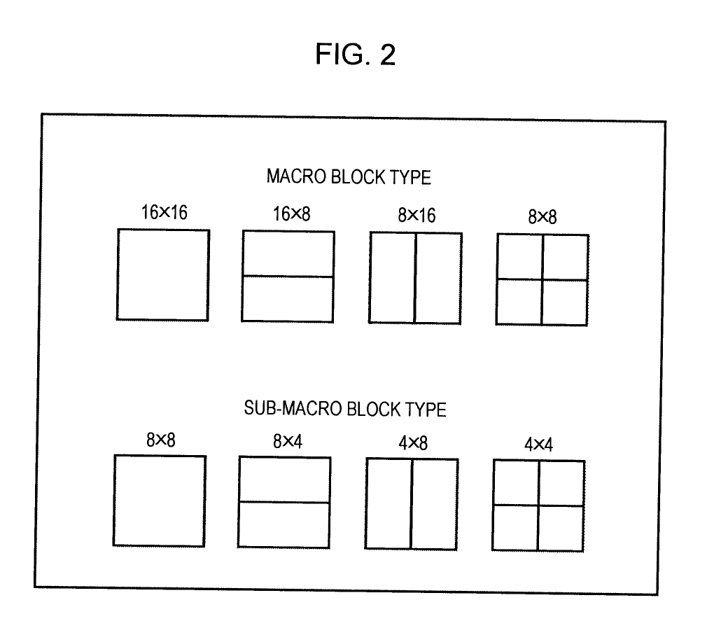

With the H.264/AVC format, motion prediction/compensation processing is performed with variable block sizes. That is to say, with the H.264/AVC format, a macro block configured of 16×16 pixels can be divided into partitions of any one of 16×16, 16×8, 8×16, or 8×8, with each having independent motion vector information, as shown in FIG. 2. Also, a partition of 8×8 can be divided into sub-partitions of any one of 8×8, 8×4, 4×8, or 4×4, with each having independent motion vector information, as shown in FIG. 2.

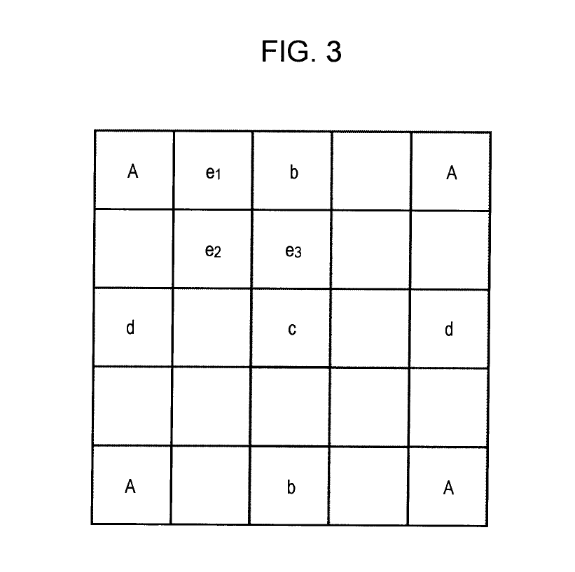

Also, with the H.264/AVC format, quarter-pixel precision motion prediction/compensation is performed using 6-tap FIR (Finite Impulse Response Filter). Sub-pixel precision motion prediction/compensation processing in the H.264/AVC format will be described with reference to FIG. 3.

In the example in FIG. 3, a position A indicates integer-precision pixel positions, positions b, c, and d indicate half-pixel precision positions, and positions e1, e2. and e3 indicate quarter-pixel precision positions. First, in the following Clip( ) is defined as in the following Expression (1).

$$\begin{matrix}[ Mathematical Expression 3 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

Note that in the event that the input image is of 8-bit precision, the value of max_pix is 255.

The pixel values at positions b and d are generated as with the following Expression (2), using a 6-tap FIR filter.

[Mathematical Expression 4]

F=A₋₂−5A₋₁+20·A₀+20·A₁−5·A₂+A₃

b,d=Clip1((F+16)>>5) (2)

The pixel value at the position c is generated as with the following Expression (3), using a 6-tap FIR filter in the horizontal direction and vertical direction.

[Mathematical Expression 5]

F=b₋₂−5·b₋₁+20·b₀+20·b₁−5·b₂+b₃

or

F=d₋₂−5·d₋₁+20·d₀+20·d₁−5·d₂+d₃

c=Clip1((F+512)>>10) (3)

Note that Clip processing is performed just once at the end, following having performed product-sum processing in both the horizontal direction and vertical direction.

The positions e1 through e3 are generated by linear interpolation as with the following Expression (4).

[Mathematical Expression 6]

e₁=(A+b+1)>>1

e₂=(b+d+1)>>1

e₃=(b+c+1)>>1 (4)

Returning to FIG. 1, the A/D converter 61 performs A/D conversion of input images, and outputs to the screen rearranging buffer 62 so as to be stored. The screen rearranging buffer 62 rearranges the images of frames which are in the order of display stored, in the order of frames for encoding in accordance with the GOP (Group of Picture).

The computing unit 63 subtracts a predicted image from the intra prediction unit 74 or a predicted image from the motion prediction/compensation unit 77, selected by the prediction image selecting unit 80, from the image read out from the screen rearranging buffer 62, and outputs the difference information thereof to the orthogonal transform unit 64. The orthogonal transform unit 64 performs orthogonal transform such as disperse cosine transform, Karhunen-Loève transform, or the like, on the difference information from the computing unit 63, and outputs transform coefficients thereof. The quantization unit 65 quantizes the transform coefficients which the orthogonal transform unit 64 outputs.

The quantized transform coefficients which are output from the quantization unit 65 are input to the lossless encoding unit 66 where they are subjected to lossless encoding such as variable-length encoding, arithmetic encoding, or the like, and compressed. Note that compressed images are accumulated in the accumulation buffer 67 and then output. The rate control unit 81 controls the quantization operations of the quantization unit 65 based on the compressed images accumulated in the accumulation buffer 67.

Also, the quantized transform coefficients output from the quantization unit 65 are also input to the inverse quantization unit 68 and quantized, and subjected to inverse orthogonal transform at the inverse orthogonal transform unit 69. The output that has been subjected to inverse orthogonal transform is added with a predicted image supplied from the prediction image selecting unit 80 by the computing unit 70, and becomes a locally-decoded image. The deblocking filter 71 removes block noise in the decoded image, which is then supplied to the frame memory 72, and accumulated. The frame memory 72 also receives supply of the image before the deblocking filter processing by the deblocking filter 71, which is accumulated.

The switch 73 outputs a reference image accumulated in the frame memory 72 to the motion prediction/compensation unit 77 or the intra prediction unit 74.

With the image encoding device 51, for example, a I picture, B pictures, and P pictures, from the screen rearranging buffer 62, are supplied to the intra prediction unit 74 as images for intra-prediction. Also, B pictures and P pictures read out from the screen rearranging buffer 62 are supplied to the motion prediction/compensation unit 77 as images for inter prediction.

The intra prediction unit 74 performs intra prediction processing for all candidate intra prediction modes, based on images for intra prediction read out from the screen rearranging buffer 62 and the reference image supplied from the frame memory 72, and generates a predicted image.

Also, the intra prediction unit 74 supplies images read out from the screen rearranging buffer 62 for intra prediction and the reference image supplied from the frame memory 72 via the switch 73, to the luminance intra TP motion prediction/compensation unit 75.

The intra prediction unit 74 calculates a cost function value for all candidate intra prediction modes. The intra prediction unit 74 determines the prediction mode which gives the smallest value of the calculated cost function values and the cost function values for the intra template prediction modes calculated by the luminance intra TP motion prediction/compensation unit 75, to be an optimal intra prediction mode.

The intra prediction unit 74 supplies the predicted image generated in the optimal intra prediction mode and the cost function value thereof to the prediction image selecting unit 80. In the event that the predicted image generated in the optimal intra prediction mode is selected by the prediction image selecting unit 80, the intra prediction unit 74 supplies information relating to the optimal intra prediction mode to the lossless encoding unit 66. The lossless encoding unit 66 encodes this information so as to be a part of the header information in the compressed image.

The luminance intra TP motion prediction/compensation unit 75 performs motion prediction and compensation processing of luminance signals in the intra template prediction mode, based on the images for intra prediction read out from the screen rearranging buffer 62 and the reference image supplied from the frame memory 72, and generates a predicted image of luminance signals. The luminance intra TP motion prediction/compensation unit 75 supplies the image for intra prediction read out from the screen rearranging buffer 62, the reference image supplied from the frame memory 72, and the motion vector information searched in the motion prediction and compensation processing of the luminance signal, to the color difference intra TP motion prediction/compensation unit 76.

Also, the luminance intra TP motion prediction/compensation unit 75 calculates a cost function value for the intra template prediction mode, and supplies the calculated cost function value and predicted image (luminance signals and color difference signals) to the intra prediction unit 74.

The color difference intra TP motion prediction/compensation unit 76 performs motion prediction and compensation processing of color difference signals in the intra template prediction mode, based on the images for intra prediction read out from the screen rearranging buffer 62 and the reference image supplied from the frame memory 72, and generates a predicted image of color difference signals.

At this time, the color difference intra TP motion prediction/compensation unit 76 obtains a search range using the motion vector information searched by the luminance intra TP motion prediction/compensation unit 75, and performs motion prediction within the obtained predetermined search range. That is to say, the color difference intra TP motion prediction/compensation unit 76 only searches pixels around the motion vector information searched by the luminance intra TP motion prediction/compensation unit 75.

The color difference intra TP motion prediction/compensation unit 76 supplies the generated predicted image of color difference signals to the luminance intra TP motion prediction/compensation unit 75.

The motion prediction/compensation unit 77 performs motion prediction/compensation processing for all candidate intra prediction modes. That is to say, the motion prediction/compensation unit 77 detects motion vectors for all candidate intra prediction modes based on the images for inter prediction read out from the screen rearranging buffer 62, and the reference image supplied from the frame memory 72 via the switch 73, subjects the reference image to motion prediction and compensation processing based on the motion vectors, and generates a predicted image.

Also, the motion prediction/compensation unit 77 supplies the images for inter prediction read out from the screen rearranging buffer 62, and the reference image supplied from the frame memory 72 via the switch 73 to the luminance inter TP motion prediction/compensation unit 78.

The motion prediction/compensation unit 77 calculates cost function values for all candidate inter prediction modes. The motion prediction/compensation unit 77 determines the prediction mode which gives the smallest value of the calculated cost function values as to the inter prediction modes and the cost function values for the inter template prediction modes calculated by the luminance inter TP motion prediction/compensation unit 78, to be an optimal intra prediction mode.

The motion prediction/compensation unit 77 supplies the predicted image generated by the optimal inter prediction mode, and the cost function values thereof, to the prediction image selecting unit 80. In the event that the predicted image generated in the optimal inter prediction mode is selected by the prediction image selecting unit 80, the motion prediction/compensation unit 77 outputs the information relating to the optimal inter prediction mode and information corresponding to the optimal inter prediction mode (motion vector information, reference frame information, etc.) to the lossless encoding unit 66. The lossless encoding unit 66 subjects also the information from the motion prediction/compensation unit 77 to lossless encoding such as variable-length encoding, arithmetic encoding, or the like, and inserts this to the header portion of the compressed image.

The luminance inter TP motion prediction/compensation unit 78 performs motion prediction and compensation processing of luminance signals in the inter template prediction mode, based on images for inter prediction output from the screen rearranging buffer 62, and the reference image supplied from the frame memory 72, and generates a predicted image of luminance signals. The luminance inter TP motion prediction/compensation unit 78 supplies the images for inter prediction read out from the screen rearranging buffer 62, the reference image supplied from the frame memory 72, and motion vector information searched in the luminance signal motion prediction and compensation processing, to the color difference inter TP motion prediction/compensation unit 79.

Also, the luminance inter TP motion prediction/compensation unit 78 calculates cost function values as to the inter template prediction mode, and supplies the calculated cost function values and predicted image (luminance signals and color difference signals) to the motion prediction/compensation unit 77.

The color difference inter TP motion prediction/compensation unit 79 performs motion prediction and compensation processing for color difference signals for the inter template prediction mode, based on the images for inter prediction read out from the screen rearranging buffer 62, and the reference image supplied from the frame memory 72, and generates a predicted image of color difference signals.

At this time, the color difference inter TP motion prediction/compensation unit 79 obtains a search range using motion vector information searched by the luminance inter TP motion prediction/compensation unit 78, and performs motion prediction within the predetermined search range that has been obtained. That is to say, the color difference inter TP motion prediction/compensation unit 79 only searches pixels around the motion vector information searched by the luminance inter TP motion prediction/compensation unit 78.

The color difference inter TP motion prediction/compensation unit 79 supplies the generated color difference signal predicted image to the luminance inter TP motion prediction/compensation unit 78.

The prediction image selecting unit 80 determines the optimal mode from the optimal intra prediction mode and optimal inter prediction mode, based on the cost function values output from the intra prediction unit 74 or motion prediction/compensation unit 77, selects the predicted image of the optimal prediction mode that has been determined, and supplies this to the computing units 63 and 70. At this time, the prediction image selecting unit 80 supplies the selection information of the predicted image to the intra prediction unit 74 or motion prediction/compensation unit 77.

The rate control unit 81 controls the rate of quantization operations of the quantization unit 65 so that overflow or underflow does not occur, based on the compressed images accumulated in the accumulation buffer 67.

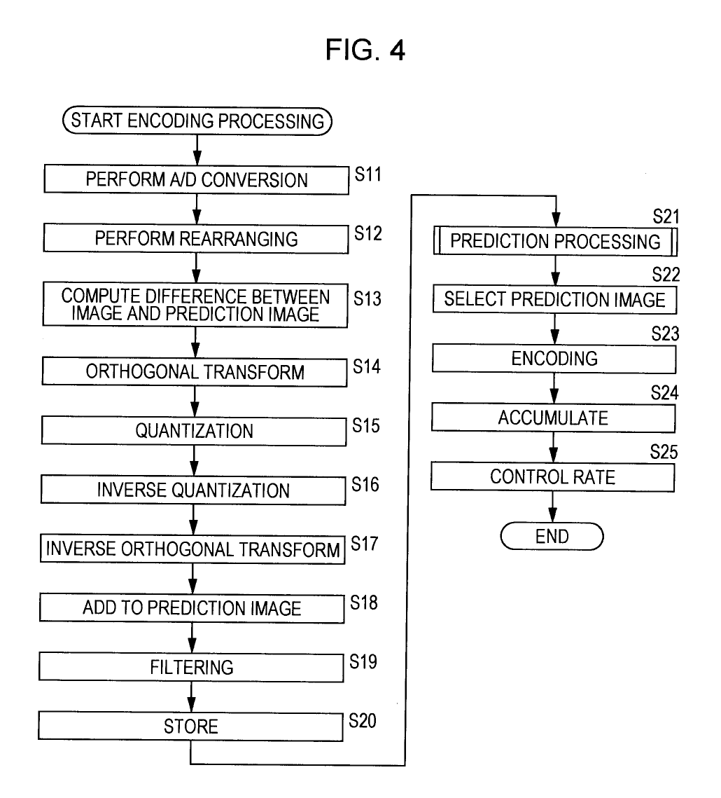

Next, the encoding processing of the image encoding device 51 in FIG. 1 will be described with reference to the flowchart in FIG. 4.

In step S11, the A/D converter 61 performs A/D conversion of an input image. In step S12, the screen rearranging buffer 62 stores the image supplied from the A/D converter 61, and performs rearranged of the pictures from the display order to the encoding order.

In step S13, the computing unit 63 computes the difference between the image rearranged in step S12 and a prediction image. The prediction image is supplied from the motion prediction/compensation unit 77 in the case of performing inter prediction, and from the intra prediction unit 74 in the case of performing intra prediction, to the computing unit 63 via the prediction image selecting unit 80.

The amount of data of the difference data is smaller in comparison to that of the original image data. Accordingly, the data amount can be compressed as compared to a case of performing encoding of the image as it is.

In step S14, the orthogonal transform unit 64 performs orthogonal transform of the difference information supplied from the computing unit 63. Specifically, orthogonal transform such as disperse cosine transform, Karhunen-Loève transform, or the like, is performed, and transform coefficients are output. In step S15, the quantization unit 65 performs quantization of the transform coefficients. The rate is controlled for this quantization, as described with the processing in step S25 described later.

The difference information quantized as described above is locally decoded as follows. That is to say, in step S16, the inverse quantization unit 68 performs inverse quantization of the transform coefficients quantized by the quantization unit 65, with properties corresponding to the properties of the quantization unit 65. In step S17, the inverse orthogonal transform unit 69 performs inverse orthogonal transform of the transform coefficients subjected to inverse quantization at the inverse quantization unit 68, with properties corresponding to the properties of the orthogonal transform unit 64.

In step S18, the computing unit 70 adds the predicted image input via the prediction image selecting unit 80 to the locally decoded difference information, and generates a locally decoded image (image corresponding to the input to the computing unit 63). In step S19, the deblocking filter 71 performs filtering of the image output from the computing unit 70. Accordingly, block noise is removed. In step S20, the frame memory 72 stores the filtered image. Note that the image not subjected to filter processing by the deblocking filter 71 is also supplied to the frame memory 72 from the computing unit 70, and stored.

In step S21, the intra prediction unit 74, luminance intra TP motion prediction/compensation unit 75, color difference intra TP motion prediction/compensation unit 76, motion prediction/compensation unit 77, luminance inter TP motion prediction/compensation unit 78, and color difference inter TP motion prediction/compensation unit 79 perform their respective image prediction processing. That is to say, in step S21, the intra prediction unit 74 performs intra prediction processing in the intra prediction mode, and the luminance intra TP motion prediction/compensation unit 75 and color difference intra TP motion prediction/compensation unit 76 perform motion prediction/compensation processing in the intra template prediction mode. Also, the motion prediction/compensation unit 77 performs motion prediction/compensation processing in the inter prediction mode, and the luminance inter TP motion prediction/compensation unit 78 and color difference inter TP motion prediction/compensation unit 79 perform motion prediction/compensation processing in the inter template prediction mode.

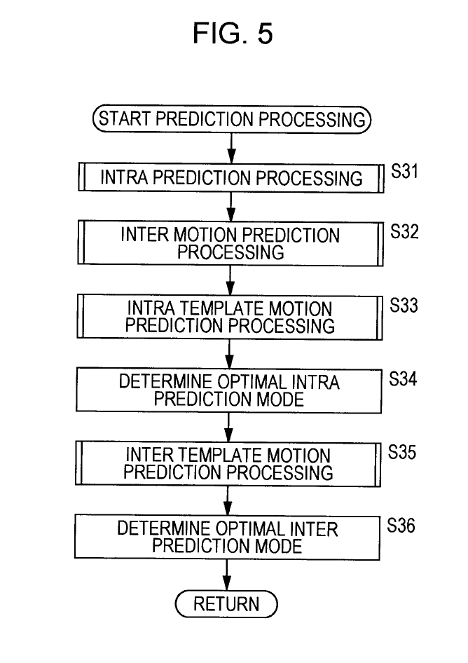

While the details of the prediction processing in step S21 will be described later in detail with reference to FIG. 5, with this processing, prediction processing is performed in each of all candidate prediction modes, and cost function values are each calculated in all candidate prediction modes. An optimal intra prediction mode is selected based on the selected const function value, and the predicted image generated by the intra prediction in the optimal intra prediction mode and the cost function value are supplied to the prediction image selecting unit 80. Also, an optimal inter prediction mode is determined from the inter prediction mode and inter template prediction mode based on the calculated cost function value, and the predicted image generated with the optimal inter prediction mode and the const function value thereof are supplied to the prediction image selecting unit 80.

In step S22, the prediction image selecting unit 80 determines one of the optimal intra prediction mode and optimal inter prediction mode as the optimal prediction mode, based on the respective cost function values output from the intra prediction unit 74 and the motion prediction/compensation unit 77, selects the predicted image of the determined optimal prediction mode, and supplies this to the computing units 63 and 70. The predicted image is used for computation in steps S13 and S18, as described above.

Note that the selection information of the predicted image is supplied to the intra prediction unit 74 or motion prediction/compensation unit 77. In the event that the predicted image of the optimal intra prediction mode is selected, the intra prediction unit 74 supplies information relating to the optimal intra prediction mode (i.e., intra mode information or intra template prediction mode information) to the lossless encoding unit 66.

In the event that the predicted image of the optimal inter prediction mode is selected, the motion prediction/compensation unit 77 outputs information relating to the optimal inter prediction mode, and information corresponding to the optimal inter prediction mode (motion vector information, reference frame information, etc.), to the lossless encoding unit 66. That is to say, in the event that the predicted image with the inter prediction mode is selected as the optimal inter prediction mode, the motion prediction/compensation unit 77 outputs inter prediction mode information, motion vector information, and reference frame information to the lossless encoding unit 66. On the other hand, in the event that an a prediction image with the inter template prediction mode is selected, the motion prediction/compensation unit 77 outputs inter template prediction mode information to the lossless encoding unit 66.

In step S23, the lossless encoding unit 66 encodes the quantized transform coefficients output from the quantization unit 65. That is to say, the difference image is subjected to lossless encoding such as variable-length encoding, arithmetic encoding, or the like, and compressed. At this time, the information relating to the optimal intra prediction mode from the intra prediction unit 74 or the information relating to the optimal inter prediction mode form the motion prediction/compensation unit 77 (prediction mode information, motion vector information, reference frame information, etc.) and so forth also is encoded and added to the header information.

In step S24, the accumulation buffer 67 accumulates the difference image as a compressed image. The compressed image accumulated in the accumulation buffer 67 is read out as appropriate, and transmitted to the decoding side via the transmission path.

In step S25, the rate control unit 81 controls the rate of quantization operations of the quantization unit 65 so that overflow or underflow does not occur, based on the compressed images accumulated in the accumulation buffer 67.

Next, the prediction processing in step S21 of FIG. 4 will be described with reference to the flowchart in FIG. 5.

In the event that the image to be processed that is supplied from the screen rearranging buffer 62 is a block image for intra processing, a decoded image to be referenced is read out from the frame memory 72, and supplied to the intra prediction unit 74 via the switch 73. Based on these images, in step S31 the intra prediction unit 74 performs intra prediction of pixels of the block to be processed for all candidate prediction modes. Note that for decoded pixels to be referenced, pixels not subjected to deblocking filtering by the deblocking filter 71 are used.

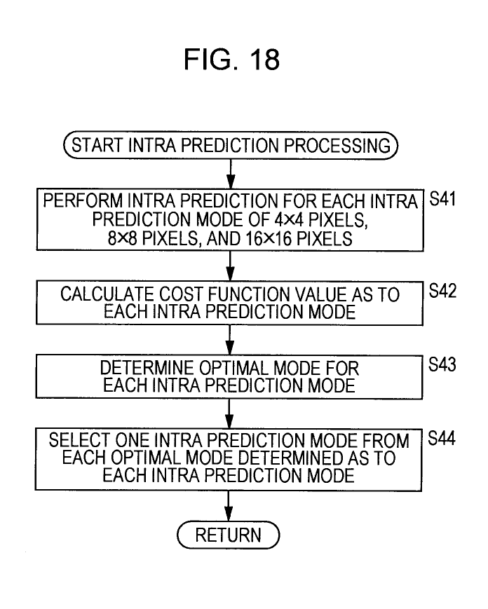

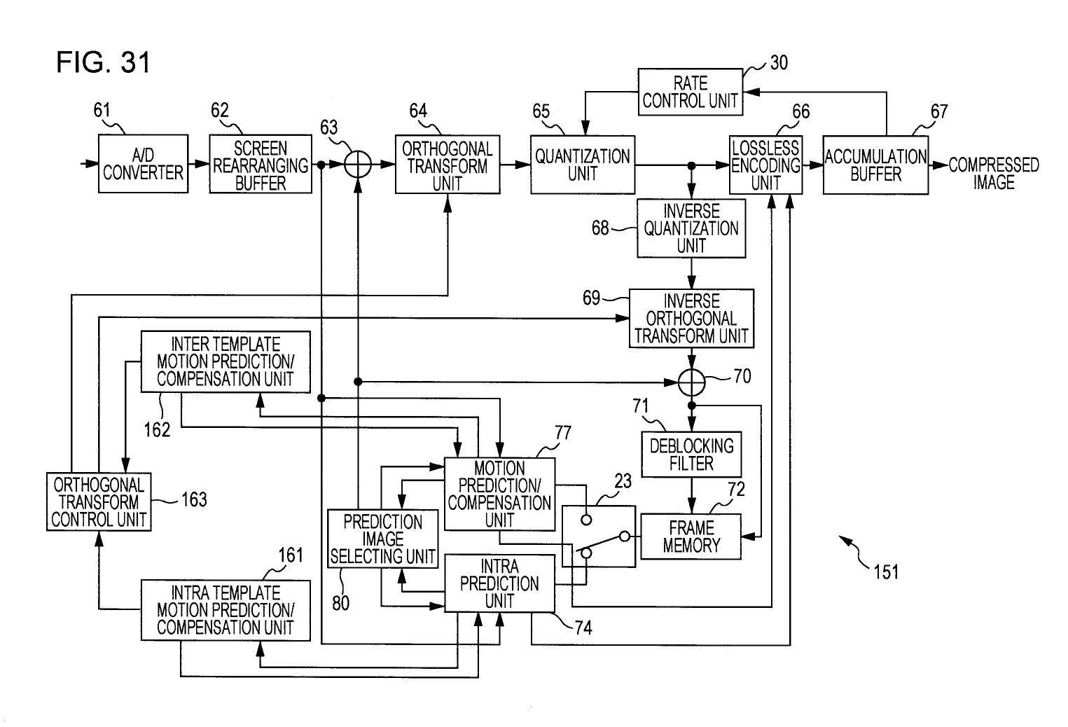

While the details of the intra prediction processing in FIG. 31 will be described later with reference to FIG. 18, due to this processing intra prediction is performed in all candidate intra prediction modes, and cost function values are calculated for all candidate intra prediction modes. One intra prediction mode is then selected from all intra prediction modes as the optimal one, based on the calculated cost function values.

In the event that the image to be processed that is supplied from the screen rearranging buffer 62 is an image for inter processing, the image to be referenced is read out from the frame memory 72, and supplied to the motion prediction/compensation unit 77 via the switch 73. In step S32, the motion prediction/compensation unit 77 performs motion prediction/compensation processing based on these images. That is to say, the motion prediction/compensation unit 77 references the image supplied from the frame memory 72 and performs motion prediction processing for all candidate inter prediction modes.

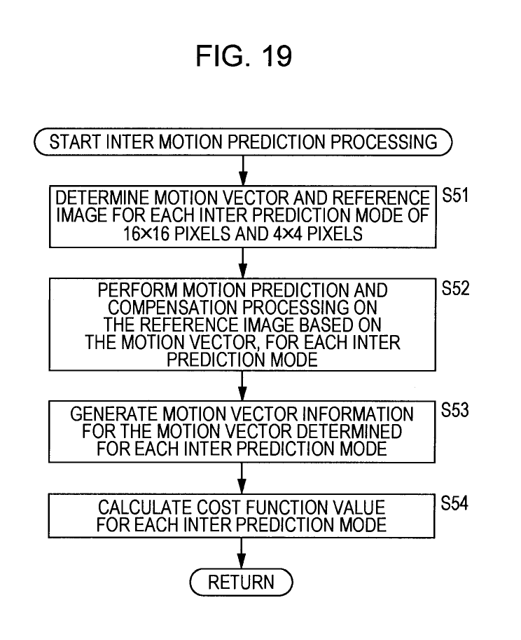

While details of the inter motion prediction processing in step S32 will be described later with reference to FIG. 19, due to this processing prediction processing is performed for all candidate inter prediction modes, and cost function values are calculated for all candidate inter prediction modes.

Also, in the event that the image to be processed that is supplied from the screen rearranging buffer 62 is a block image for inter processing, the image to be referenced is read out from the frame memory 72, and also supplied to the luminance intra TP motion prediction/compensation unit 75 via the intra prediction unit 74. In step S33, the luminance intra TP motion prediction/compensation unit 75 and the color difference intra TP motion prediction/compensation unit 76 perform intra template motion prediction processing in the intra template prediction mode.

While the details of the intra template motion prediction processing in step S33 will be described later with reference to FIG. 21, due to this processing motion prediction processing is performed in the intra template prediction mode, and cost function values are calculated as to the intra template prediction mode. The predicted image generated by the motion prediction processing for the intra template prediction mode, and the cost function value thereof are supplied to the intra prediction unit 74.

In step S34, the intra prediction unit 74 compares the cost function value as to the intra prediction mode selected in step S31 and the cost function value as to the intra template prediction mode selected in step S33, and determines the prediction mode which gives the smallest value to be the optimal intra prediction mode. The intra prediction unit 74 then supplies the predicted image generated in the optimal intra prediction mode and the cost function value thereof to the prediction image selecting unit 80.

Further, in the event that the image to be processed that is supplied from the screen rearranging buffer 62 is an image for inter processing, the image to be referenced is read out from the frame memory 72, and supplied to the luminance inter TP motion prediction/compensation unit 78 via the switch 73 and the motion prediction/compensation unit 77. Based on these images, the luminance inter TP motion prediction/compensation unit 78 and the color difference inter TP motion prediction/compensation unit 79 perform inter template motion prediction processing in the inter template prediction mode in step S35.

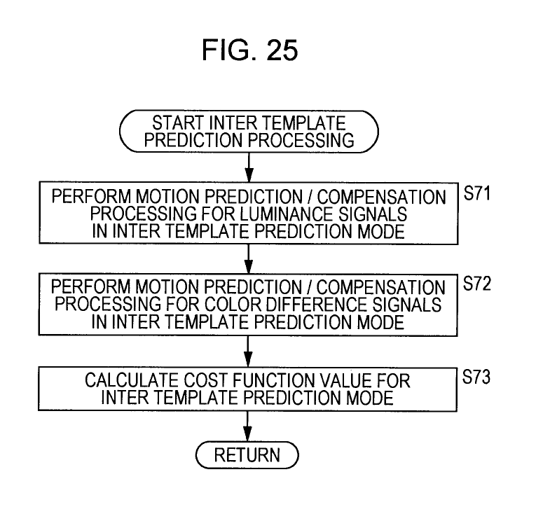

While details of the inter template motion prediction processing in step S35 will be described later with reference to FIG. 25, due to this processing motion prediction processing is performed in the inter template prediction mode, and cost function values as to the inter template prediction mode are calculated. The predicted image generated by the motion prediction processing in the inter template prediction mode and the cost function value thereof are supplied to the motion prediction/compensation unit 77.

In step S36, the motion prediction/compensation unit 77 compares the cost function value as to the optimal inter prediction mode selected in step S32 with the cost function value calculated as to the inter template prediction mode, and determines the prediction mode which gives the smallest value to be the optimal inter prediction mode. The motion prediction/compensation unit 77 then supplies the predicted image generated in the optimal inter prediction mode and the cost function value thereof to the prediction image selecting unit 80.

Next, the modes for intra prediction that are stipulated in the H.264/AVC format will be described.

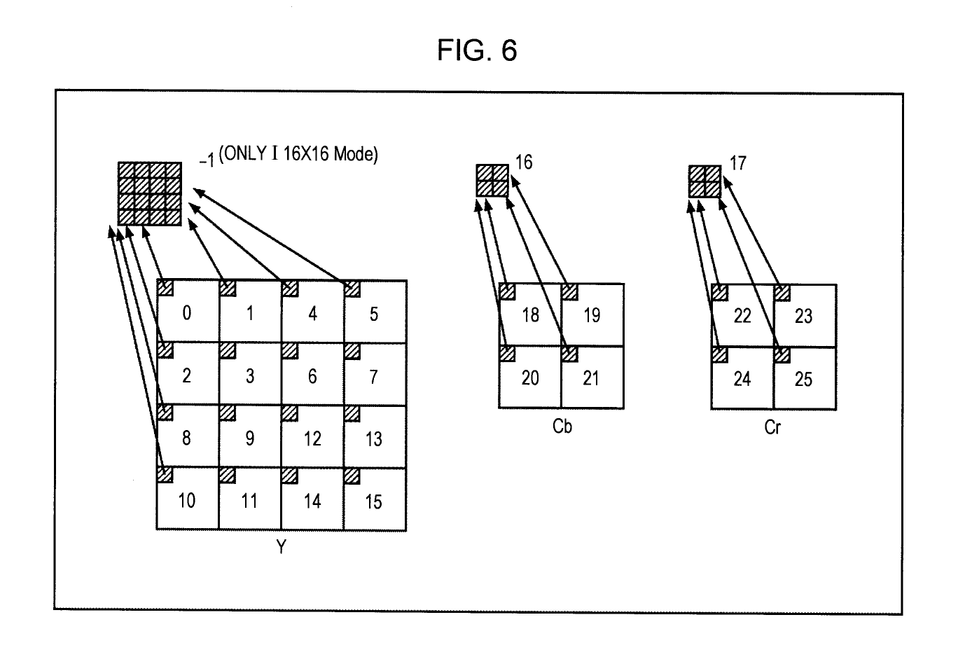

First, the intra prediction modes as to luminance signals will be described. The luminance signal intra prediction mode include nine types of prediction modes in increments of 4×4 pixels, and four types of prediction modes in macro block increments of 16×16 pixels. In the example in FIG. 6, the numerals −1 through 25 given to each block represent the order of each block in the bit stream (processing order at the decoding side). With regard to luminance signals, a macro block is divided into 4×4 pixels, and DCT is performed for the 4×4 pixels. Additionally, in the case of the intra prediction mode of 16×16 pixels, the direct current component of each block is gathered and a 4×4 matrix is generated, and this is further subjected to orthogonal transform, as indicated with the block −1.

On the other hand, with regard to color difference signals, a macro block is divided into 4×4 pixels, and DCT is performed for the 4×4 pixels, following which the direct current component of each block is gathered and a 2×2 matrix is generated, and this is further subjected to orthogonal transform as indicated with the blocks 16 and 17.

As for High Profile, a prediction mode in 8×8 pixel block increments is stipulated as to 8′th order DCT blocks, this method being pursuant to the 4×4 pixel intra prediction mode method described next. That is to say, prediction modes in 8×8 pixel block increments can only be applied in cases where 8×8 pixel orthogonal transform is performed, to object macro blocks, with High Profile or a higher profile.

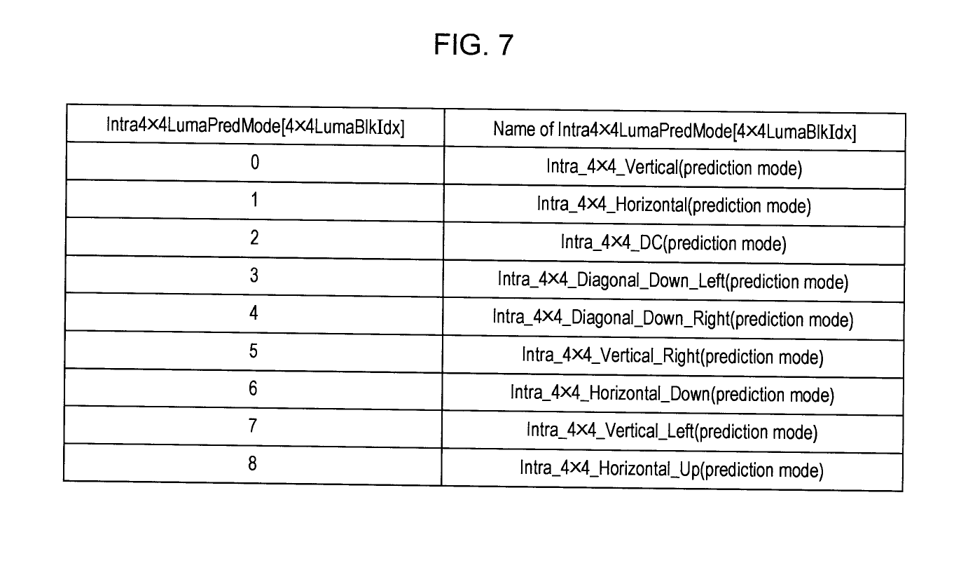

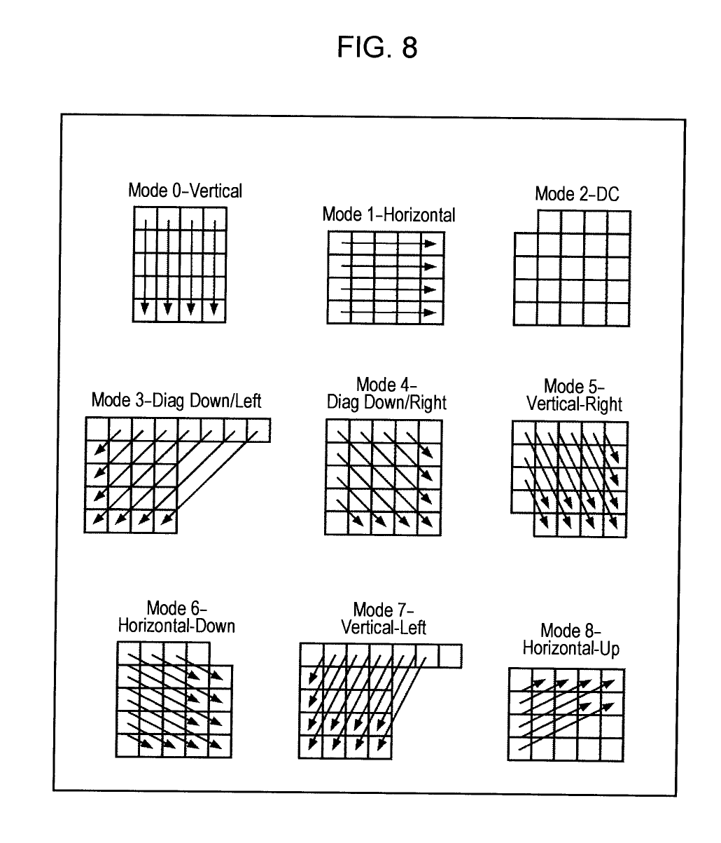

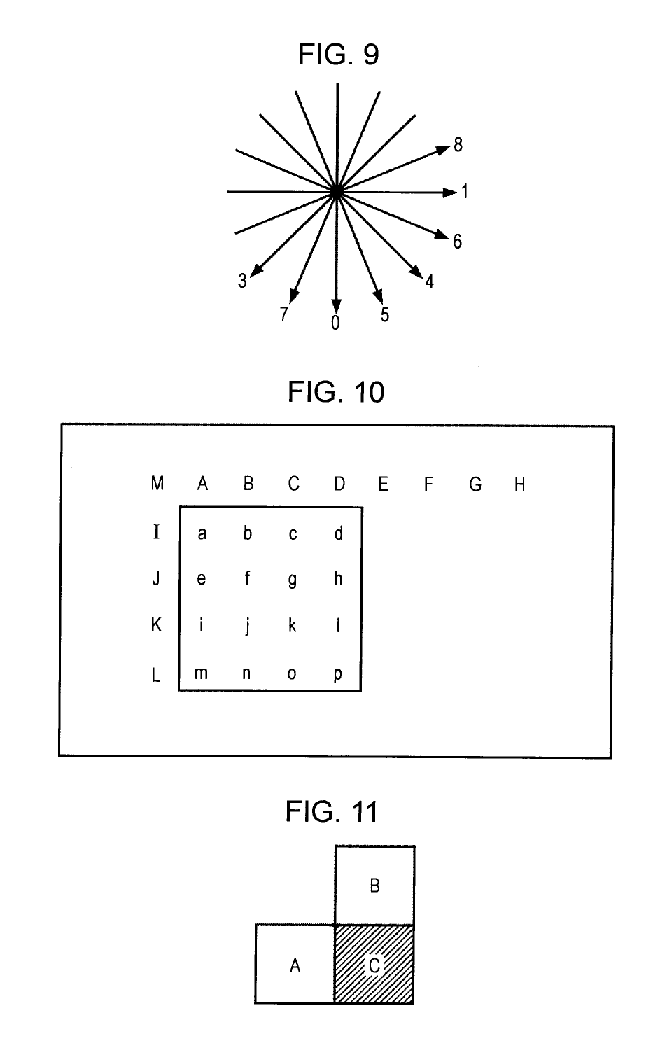

FIG. 7 and FIG. 8 are diagrams illustrating the nine types of luminance signal 4×4 pixel intra prediction modes (Intra_{—} 4×4_pred_mode). The eight types of modes other than mode 2 which indicates average value (DC) prediction are each corresponding to the directions indicated by 0, 1, and 3 through 8, in FIG. 9.

The nine types of Intra_{—}4×4_pred_mode will be described with reference to FIG. 10. In the example in FIG. 10, the pixels a through p represent the object blocks to be subjected to intra processing, and the pixel values A through M represent the pixel values of pixels belonging to adjacent blocks. That is to say, the pixels a through p are the image to be processed that has been read out from the screen rearranging buffer 62, and the pixel values A through M are pixels values of the decoded image to be referenced that has been read out from the frame memory 72.

In the event of each intra prediction mode in FIG. 7 and FIG. 8, the predicted pixel values of pixels a through p are generated as follows using the pixel values A through M of pixels belonging to adjacent blocks. Note that in the event that the pixel value is “available”, this represents that the pixel is available with no reason such as being at the edge of the image frame or being still encoded, and in the event that the pixel value is “unavailable”, this represents that the pixel is unavailable due to a reason such as being at the edge of the image frame or being still encoded.

Mode 0 is a Vertical Prediction mode, and is applied only in the event that pixel values A through D are “available”. In this case, the prediction values of pixels a through p are generated as in the following Expression (5).

Prediction pixel value of pixels a,e,i,m=A

Prediction pixel value of pixels b,f,j,n=B

Prediction pixel value of pixels c,g,k,o=C

Prediction pixel value of pixels d,h,l,p=D (5)

Mode 1 is a Horizontal Prediction mode, and is applied only in the event that pixel values I through L are “available”. In this case, the prediction values of pixels a through p are generated as in the following Expression (6).

Prediction pixel value of pixels a,b,c,d=I

Prediction pixel value of pixels e,f,g,h=J

Prediction pixel value of pixels i,j,k,l=K

Prediction pixel value of pixels m,n,o,p=L (6)

Mode 2 is a DC Prediction mode, and prediction pixel values are generated as in the following Expression (7) in the event that pixel values A, B, C, D, I, J, K, L are all “available”.

(A+B+C+D+I+J+K+L+4)>>3 (7)

Also, prediction pixel values are generated as in the following Expression (8) in the event that pixel values A, B, C, D are all “unavailable”.

(I+J+K+L)>>2 (8)

Also, prediction pixel values are generated as in the following Expression (9) in the event that pixel values I, J, K, L are all “unavailable”.

(A+B+C+D)>>2 (9)

Also, the event that pixel values A, B, C, D, I, J, K, L are all “unavailable”, 128 is generated as a prediction pixel value.

Mode 3 is a Diagonal_Down_Left Prediction mode, and prediction pixel values are generated only in the event that pixel values A, B, C, D, I, J, K, L, M are “available”. In this case, the pixel values of the pixels a through p are generated as in the following Expression (10).

Prediction pixel value of pixel a=(A+2B+C+2)>>2

Prediction pixel value of pixels b,e=(B+2C+D+2)>>2

Prediction pixel value of pixels c,f,i=(C+2D+E+2)>>2

Prediction pixel value of pixels d,g,j,m=(D+2E+F+2)>>2

Prediction pixel value of pixels h,k,n=(E+2F+G+2)>>2

Prediction pixel value of pixels l,o=(F+2G+H+2)>>2

Prediction pixel value of pixel p=(G+3H+2)>>2 (10)

Mode 4 is a Diagonal_Down_Right Prediction mode, and prediction pixel values are generated only in the event that pixel values A, B, C, D, I, J, K, L, M are “available”. In this case, the pixel values of the pixels a through p are generated as in the following Expression (11).

Prediction pixel value of pixel m=(J+2K+L+2)>>2

Prediction pixel value of pixels i,n=(I+2J+K+2)>>2

Prediction pixel value of pixels e,j,o=(M+2I+J+2)>>2

Prediction pixel value of pixels a,f,k,p=(A+2M+I+2)>>2

Prediction pixel value of pixels b,g,l=(M+2A+B+2)>>2

Prediction pixel value of pixels c,h=(A+2B+C+2)>>2

Prediction pixel value of pixel d=(B+2C+D+2)>>2 (11)

Mode 5 is a Diagonal_Vertical_Right Prediction mode, and prediction pixel values are generated only in the event that pixel values A, B, C, D, I, J, K, L, M are “available”. In this case, the pixel values of the pixels a through p are generated as in the following Expression (12).

Prediction pixel value of pixels a,j=(M+A+1)>>1

Prediction pixel value of pixels b,k=(A+B+1)>>1

Prediction pixel value of pixels c,l=(B+C+1)>>1

Prediction pixel value of pixel d=(C+D+1)>>1

Prediction pixel value of pixels e,n=(I+2M+A+2)>>2

Prediction pixel value of pixels f,o=(M+2A+B+2)>>2

Prediction pixel value of pixels g,p=(A+2B+C+2)>>2

Prediction pixel value of pixel h=(B+2C+D+2)>>2

Prediction pixel value of pixel i=(M+2I+J+2)>>2

Prediction pixel value of pixel m=(I+2J+K+2)>>2 (12)

Mode 6 is a Horizontal_Down Prediction mode, and prediction pixel values are generated only in the event that pixel values A, B, C, D, I, J, K, L, M are “available”. In this case, the pixel values of the pixels a through p are generated as in the following Expression (13).

Prediction pixel value of pixels a,g=(M+I+1)>>1

Prediction pixel value of pixels b,h=(I+2M+A+2)>>2

Prediction pixel value of pixel c=(M+2A+B+2)>>2

Prediction pixel value of pixel d=(A+2B+C+2)>>2

Prediction pixel value of pixels e,k=(I+J+1)>>1

Prediction pixel value of pixels f,l=(M+2I+J+2)>>2

Prediction pixel value of pixels i,o=(J+K+1)>>1

Prediction pixel value of pixels j,p=(I+2J+K+2)>>2

Prediction pixel value of pixel m=(K+L+1)>>1

Prediction pixel value of pixel n=(J+2K+L+2)>>2 (13)

Mode 7 is a Vertical_Left Prediction mode, and prediction pixel values are generated only in the event that pixel values A, B, C, D, I, J, K, L, M are “available”. In this case, the pixel values of the pixels a through p are generated as in the following Expression (14).

Prediction pixel value of pixel a=(A+B+1)>>1

Prediction pixel value of pixels b,i=(B+C+1)>>1

Prediction pixel value of pixels c,j=(C+D+1)>>1

Prediction pixel value of pixels d,k=(D+E+1)>>1

Prediction pixel value of pixel l=(E+F+1)>>1

Prediction pixel value of pixel e=(A+2B+C+2)>>2

Prediction pixel value of pixels f,m=(B+2C+D+2)>>2

Prediction pixel value of pixels g,n=(C+2D+E+2)>>2

Prediction pixel value of pixels h,o=(D+2E+F+2)>>2

Prediction pixel value of pixel p=(E+2F+G+2)>>2 (14)

Mode 8 is a Horizontal_Up Prediction mode, and prediction pixel values are generated only in the event that pixel values A, B, C, D, I, J, K, L, M are “available”. In this case, the pixel values of the pixels a through p are generated as in the following Expression (15).

Prediction pixel value of pixel a=(I+J+1)>>1

Prediction pixel value of pixels b=(I+2J+K+2)>>2

Prediction pixel value of pixels c,e=(J+K+1)>>1

Prediction pixel value of pixels d,f=(J+2K+L+2)>>2

Prediction pixel value of pixels g,i=(K+L+1)>>1

Prediction pixel value of pixels h,j=(K+3L+2)>>2

Prediction pixel value of pixels k, l, m, n, o, p=L (15)

Next, the intra prediction mode (Intra_{—}4×4_pred_mode) encoding method for 4×4 pixel luminance signals will be described with reference to FIG. 11.

In the example in FIG. 11, an object block C to be encoded which is made up of 4×4 pixels is shown, and a block A and block B which are made up of 4×4 pixel and are adjacent to the object block C are shown.

In this case, the Intra_{—}4×4_pred_mode in the object block C and the Intra_{—}4×4_pred_mode in the block A and block B are though to have high correlation. Performing the following encoding processing using this correlation allows higher encoding efficiency to be realized.

That is to say, in the example in FIG. 11, with the Intra_{—}4×4_pred_mode in the block A and block B as Intra_{—}4×4_pred_modeA and Intra_{—}4×4_pred_modeB respectively, the MostProbableMode is defined as the following Expression (16).

MostProbableMode=Min(Intra_{—}4×4_pred_modeA, Intra_{—}4×4_pred_modeB) (16)

That is to say, of the block A and block B, that with the smaller mode_number allocated thereto is taken as the MostProbableMode.

There are two values of prev_intra4×4_pred_mode_flag[luma4×4BlkIdx] and rem_intra4×4_pred_mode[luma4×4BlkIdx] defined as parameters as to the object block C in the bit stream, with decoding processing being performed by processing based on the pseudocode shown in the following Expression (17), so the values of Intra_{—}4×4_pred_mode, Intra4×4PredMode[luma4×4BlkIdx] as to the object block C can be obtained.

if (prev_intra4×4_pred_mode_flag[luma4×4BlkIdx])

Intra4×4PredMode[luma4×4BlkIdx]=MostProbableMode

else

if (rem_intra4×4_pred_mode[luma4×4BlkIdx]<MostProbableMode)

Intra4×4PredMode[luma4×4BlkIdx]=rem_intra4×4_pred_mode[luma4×4BlkIdx]

else

Intra4×4PredMode[luma4×4BlkIdx]=rem_intra4×4_pred_mode[luma4×4BlkIdx]+1 (17)

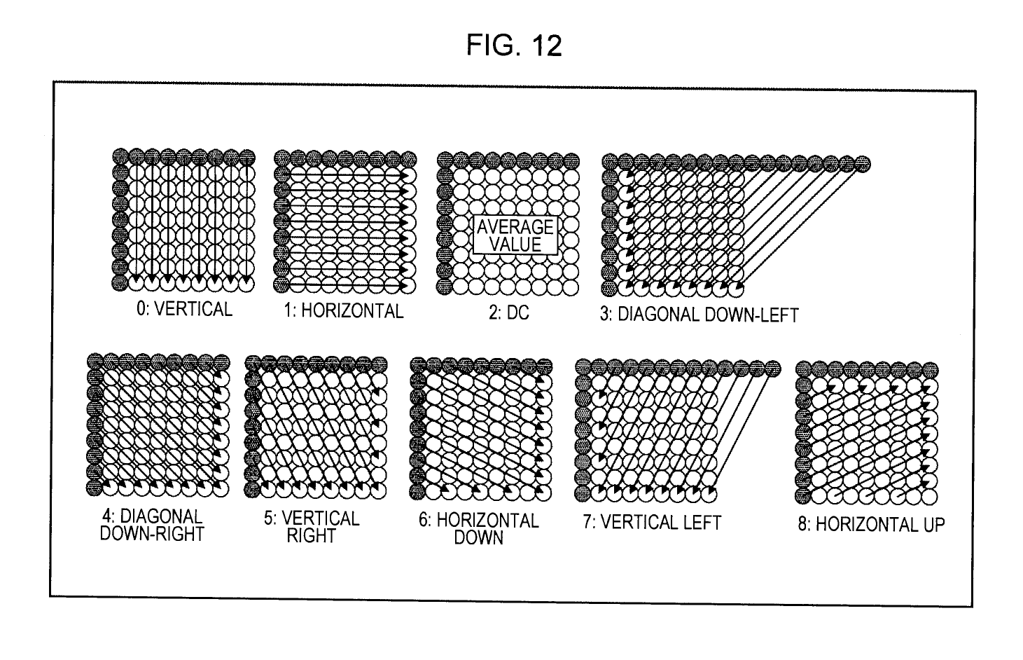

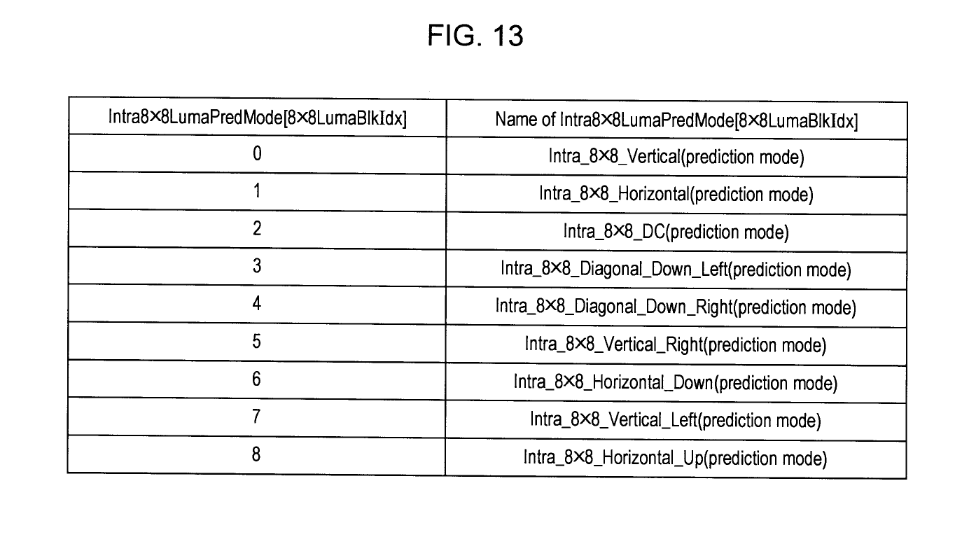

Next, the 8×8 pixel intra prediction mode will be described. FIG. 12 and FIG. 13 are diagrams illustrating the nine types of 8×8 pixels luminance signal intra prediction modes (Intra_{—}8×8_pred_mode).

We will say that the pixel values in the object 8×8 block are p[x,y] (0≦x≦7; 0≦y≦7), and the pixel values of the adjacent block are expressed as p[−1,−1], . . . , p[−1,15], p[−1,0], . . . , [p−1,7]

With the 8×8 pixel intra prediction mode, before generating prediction values, low-pass filtering processing is applied to the adjacent pixels. Now, we will say that the pixel values before the low-pass filtering processing are expressed as p[−1,−1], . . . , p[−1,15], p[−1,0], . . . p[−1,7] and the pixel values after the low-pass filtering processing are expressed as p′[−1,−1], . . . , p′[−1,15], p′[−1,0], . . . p′[−1,7]

First, in the event that p[−1,−1] is “available”, p′[0,−1] is calculated as in the following Expression (18), and in the case of being “not available”, is calculated as in the following Expression (19).

p′[0,−1]=(p[−1,−1]+2*p[0,−1]+p[1,−1]+2)>>2 (18)

p′[0,−1]=(3*p[0,−1]+p[1,−1]+2)>>2 (19)

p′[x,−1] (x=0, . . . , 7) is calculated as in the following Expression (20).

p′[x,−1]=(p[x−1,−1]+2*p[x,−1]+p[x+1,−1]+2)>>2 (20)

In the event that p[x,−1] (x=8, . . . , 15) is “available”, p′[x,−1] (x=8, . . . , 15) is calculated as in the following Expression (21).

p′[x,−1]=(p[x−1,−1]+2*p[x,−1]+p[x+1,−1]+2)>>2

p′[15,−1]=(p[14,−1]+3*p[15,−1]+2)>>2 (21)

In the event that p[−1,−1] is “available”, p′[−1,−1] is calculated as in the following.

That is to say, in the event that both p[0,−1] and p[−1,0] are available, p′[−1,−1] is calculated as in Expression (22), and in the event that p[−1,0] is “unavailable”, is calculated as in Expression (23). Also, in the event that p[0,−1] is “unavailable”, p′[−1,−1] is calculated as in Expression (24).

p′[−1,−1]=(p[0,−1]+2*p[−1,−1]+p[−1,0]+2)>>2 (22)

p′[−1,−1]=(3*p[−1,−1]+p[0,−1]+2)>>2 (23)

p′[−1,−1]=(3*p[−1,−1]+p[−1,0]+2)>>2 (24)

In the event that p[−1,y] (y=0, . . . , 7) is “available”, p′[−1,y] (y=0, . . . , 7) is calculated as follows. That is to say, first, in the event that p[−1,−1] is “available”, p′[−1,0] is calculated as in Expression (25), and in the event of being “unavailable”, is calculated as in Expression (26).

p′[−1,0]=(p[−1,−1]+2*p[−1,0]+p[−1,1]+2)>>2 (25)

p′[−1,0]=(3*p[−1,0]+p[−1,1]+2)>>2 (26)

Also, p′[−1,y] (y=1, . . . , 6) is calculated as in the following Expression (27), and p′[−1,7] is calculated as in Expression (28).

p[−1,y]=(p[−1,y−1]+2*p[−1,y]+p[−1,y+1]+2)>>2 (27)

p′[−1,7]=(p[−1,6]+3*p[−1,7]+2)>>2 (28)

Prediction values in each intra prediction mode shown in FIG. 12 and FIG. 13 are generated as follows, using the p′ thus calculated.

Mode 0 is the Vertical Prediction mode, and is applied only in the event that p[x,−1] (x=0, . . . , 7) is “available”. The prediction value pred8×8_{L}[x,y] is generated as in the following Expression (29).

pred8×8_{L}[x,y]=p′[x,−1] x,y=0, . . . , 7 (29)

Mode 1 is the Horizontal Prediction mode, and is applied only in the event that p[−1,y] (y=0, . . . , 7) is “available”. The prediction value pred8×8_{L}[x,y] is generated as in the following Expression (30).

pred8×8_{L}[x,y]=p′[−1,y] x,y=0, . . . , 7 (30)

Mode 2 is the DC Prediction mode, the prediction value pred8×8_{L}[x,y] being generated as follows. That is to say, in the event that both p[x,−1] (x=0, . . . , 7) and p[−1,y] (y=0, . . . , 7) are “available”, the prediction value pred8×8_{L}[x,y] is generated as in the following Expression (31).

$$\begin{matrix}[ Mathematical Expression 7 ] & \\ Pred 8 \times {8}_{L} [ x , y ] = ( {\sum }_{{x}^{′} = 0}^{7} {P}^{′} [ {x}^{′} , - 1 ] + {\sum }_{{y}^{′} = 0}^{7} {P}^{′} [ - 1 , y ] + 8 ) >> 4 & ( 31 )\end{matrix}$$

In the event that p[x,−1] (x=0, . . . , 7) is “available” but p[−1,y] (y=0, . . . , 7) is “unavailable”, the prediction value pred8×8_{L}[x,y] is generated as in the following Expression (32).

$$\begin{matrix}[ Mathematical Expression 8 ] & \\ Pred 8 \times {8}_{L} [ x . y ] = ( {\sum }_{{x}^{′} = 0}^{7} {P}^{′} [ {x}^{′} , - 1 ] + 4 ) >> 3 & ( 32 )\end{matrix}$$

In the event that p[x,−1] (x=0, . . . , 7) is “unavailable” but p[−1,y] (y=0, . . . , 7) is “available”, the prediction value pred8×8_{L}[x,y] is generated as in the following Expression (33).

$$\begin{matrix}[ Mathematical Expression 9 ] & \\ Pred 8 \times {8}_{L} [ x , y ] = ( {\sum }_{{y}^{′} = 0}^{7} {P}^{′} [ - 1 , y ] + 4 ) >> 3 & ( 33 )\end{matrix}$$

In the event that both p[x,−1] (x=0, . . . , 7) and p[−1,y] (y=0, . . . , 7) are “unavailable”, the prediction value pred8×8_{L}[x,y] is generated as in the following Expression (34).

pred8×8_{L}[x,y]=128 (34)

where Expression (34) illustrates a case of 8-bit input.

Mode 3 is the Diagonal_Down_Left_prediction mode, and the prediction value pred8×8_{L}[x,y] is generated as follows. That is to say, the Diagonal_Down_Left_prediction mode is applied only in the event that p[x,−1], x=0, . . . , 15 is “available”, with prediction image pixels of x=7 and y=7 being generated as with the following Expression (35), and all other prediction image pixels being generated as with the following Expression (36).

pred8×8_{L}[x,y]=(p′[14,−1]+3*p[15,−1]+2)>>2 (35)

red8×8_{L}[x,y]=(p′[x+y,−1]+2*p′[x+y+1,−1]+p′[x+y+2,−1]+2)>>2 (36)

Mode 4 is the Diagonal_Down_Right_prediction mode, and the prediction value pred8×8_{L}[x,y] is generated as follows. That is to say, the Diagonal_Down_Right_prediction mode is applied only in the event that p[x,−1],x=0, . . . , 7 and p[−1,y],y=0, . . . , 7 are “available”, with prediction image pixels of x>y being generated as in the following Expression (37), and with prediction image pixels of x<y being generated as in the following Expression (38). Also, prediction image pixels of x=y are generated as in the following Expression (39).

pred8×8_{L}[x,y]=(p′[x−y−2,−1]+2*p′[x−y−1,−1]+p′[x−y,−1]+2)>>2 (37)

pred8×8_{L}[x,y]=(p′[−1,y−x−2]+2*p′[−1,y−x−1]+p′[−1,y−x]+2)>>2 (38)

pred8×8_{L}[x,y]=(p′[0,−1]+2*p′[−1,−1]+p′[−1,0]+2)>>2 (39)

Mode 5 is the Vertical_Right_prediction mode, with the prediction value pred8×8_{L}[x,y] being generated as follows. That is to say, Vertical_Right_prediction mode is applied only in the event that p[x,−1],x=0, . . . , 7 and p[−1,y],y=−1, . . . , 7 are “available”. Let us define zVR as in the following expression.

zVR=2*x−y (40)

At this time, in the event that zVR is 0, 2, 4, 6, 8, 10, 12, 14, the pixel prediction value is generated as with the following Expression (41), and in the event that zVR is 1, 3, 5, 7, 9, 11, 13, the pixel prediction value is generated as with the following Expression (42).

pred8×8_{L}[x,y]=(p′[x−(y>>1)−1,−1]+p′[x−(y>>1),−1]+1)>>1 (41)

pred8×8_{L}[x,y]=(p′[x−(y>>1)−2,−1]+2*p′[x−(y>>1)−1,−1]+p′[x−(y>>1),−1]+2)>>2 (42)

Also, in the event that zVR is −1, the pixel prediction value is generated as in the following Expression (43), and otherwise, i.e., in the event that zVR is −2, −3, −4, −5, −6, −7, the pixel prediction value is generated as in the following Expression (44).

pred8×8_{L}[x,y]=(p′[−1,0]+2*p′[−1,−1]+p′[0,−1]+2)>>2 (43)

pred8×8_{L}[x,y]=(p′[−1,y−2*x−1]+2*p′[−1,y−2*x−2]+p′[−1,y−2*x−3]+2)>>2 (44)

Mode 6 is the Horizontal_Down_prediction mode, and the prediction value pred8×8_{L}[x,y] is generated as follows. That is to say, the Horizontal_Down_prediction mode is applied only in the event that p[x,−1],x=0, . . . , 7 and p[−1,y],y=−1, . . . , 7 are “available”. Let us define zVR as in the following Expression (45).

zHD=2*y−x (45)

At this time, in the event that zHD is 0, 2, 4, 6, 8, 10, 12, 14, the prediction pixel value is generated as in the following Expression (46), and in the event that zHD is 1, 3, 5, 7, 9, 11, 13, the prediction pixel value is generated as in the following Expression (47).

pred8×8_{L}[x,y]=(p′[−1,y−(x>>1)−1]+p′[−1,y−(x>>1)+1]>>1 (46)

pred8×8_{L}[x,y]=(p′[−1,y−(x>>1)−2]+2*p′[−1,y−(x>>1)−1]+p′[−1,y−(x>>1)]+2)>>2 (47)

Also, in the event that zHD is −1, the prediction pixel value is generated as in the following Expression (48), and in the event that zHD is any other value, i.e., in the event of −2, −3, −4, −5, −6, −7, the prediction pixel value is generated as in the following Expression (49).

pred8×8_{L}[x,y]=(p′[−1,0]+2*p[−1,−1]+p′[0,−1]+2)>>2 (48)

pred8×8_{L}[x,y]=(p′[x−2*y−1,−1]+2*p′[x−2*y−2,−1]+p′[x−2*y−3,−1]+2)>>2 (49)

Mode 7 is the Vertical_Left_prediction mode, and the prediction value pred8×8_{L}[x,y] is generated as follows. That is to say, the Vertical_Left_prediction mode is applied only in the event that p[x,−1], x=0, . . . , 15 is “available”, and in the event that y=0, 2, 4, 6, the prediction pixel value is generated as in the following Expression (50), and otherwise, i.e., in the event of y=1, 3, 5, 7, the prediction pixel value is generated as in the following Expression (51).

pred8×8_{L}[x,y]=(p′[x+(y>>1),−1]+p′[x+(y>>1)+1,−1]+1)>>1 (50)

pred8×8_{L}[x,y]=(p′[x+(y>>1),−1]+2*p′[x+(y>>1)+1,−1]+p′[x+(y>>1)+2,−1]+2)>>2 (51)

Mode 8 is the Horizontal_Up_prediction mode, and the prediction value pred8×8_{L}[x,y] is generated as follows. That is to say, Horizontal_Up_prediction mode is applied only in the event that p[−1,y], y=0, . . . , 7 is “available”. In the following, we will define zHU as in the following Expression (52).

zHU=x+2*y (52).

In the event that the value of zHU is 0, 2, 4, 6, 8, 10, 12, the prediction pixel value is generated as in the following Expression (53), and in the event that the value of zHU is 1, 3, 5, 7, 9, 11, prediction pixel value is generated as in the following Expression (54).

pred8×8_{L}[x,y]=(p′[−1,y+(x>>1)]+p′[−1,y+(x>>1)+1]+1)>>1 (53)

pred8×8_{L}[x,y]=(p′[−1,y+(x>>1)] (54)

Also, in the event that the value of zHU is 13, the prediction pixel value is generated as in the following Expression (55), and in the event that the value of zHU is greater than 13, the prediction pixel value is generated as in the following Expression (56).

pred8×8_{L}[x,y]=(p′[−1,6]+3*p′[−1,7]+2)>>2 (55)

pred8×8_{L}[x,y]=p′[−1,7] (56)

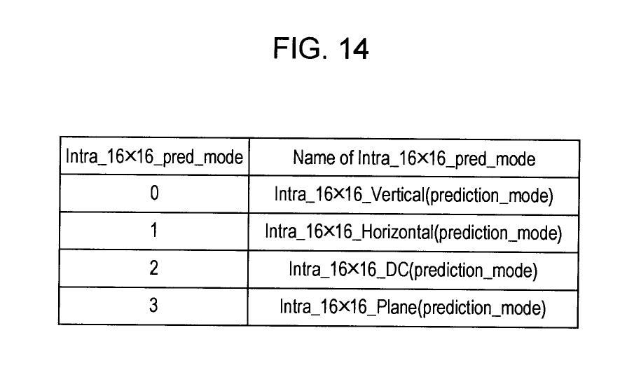

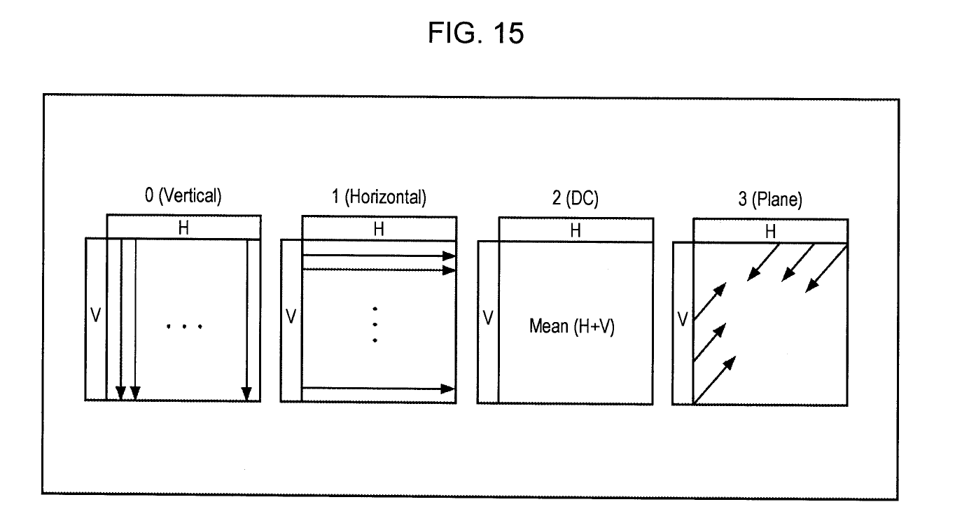

Next, description will be made regarding the 16×16 pixel intra prediction mode. FIG. 14 and FIG. 15 are diagrams illustrating the four types of 16×16 pixel luminance signal intra prediction modes (Intra_{—}16×16_pred_mode).

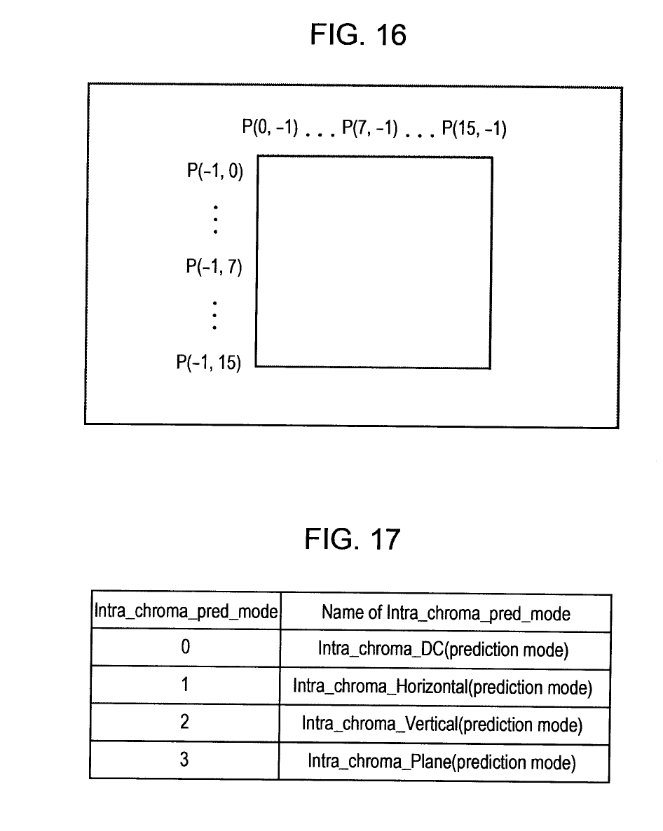

The four types of intra prediction modes will be described with reference to FIG. 16. In the example in FIG. 16, an object macro block A to be subjected to intra processing is shown, and P(x,y); x,y=−1, 0, . . . , 15 represents the pixel values of the pixels adjacent to the object macro block A.

Mode 0 is the Vertical Prediction mode, and is applied only in the event that P(x,−1); x,y=−1, 0, . . . , 15 is “available”. In this case, the prediction value Pred(x,y) of each of the pixels in the object macro block A is generated as in the following Expression (57).

Pred(x,y)=P(x,−1); x,y=0, . . . , 15 (57)

Mode 1 is the Horizontal Prediction mode, and is applied only in the event that P(−1,y); x,y=−1, 0, . . . , 15 is “available”. In this case, the prediction value Pred(x,y) of each of the pixels in the object macro block A is generated as in the following Expression (58).

Pred(x,y)=P(−1,y); x,y=0, . . . , 15 (58)

Mode 2 is the DC Prediction mode, and in the event that P(x,−1) and P(−1,y); x,y=−1, 0, . . . , 15 are all “available”, the prediction value Pred(x,y) of each of the pixels in the object macro block A is generated as in the following Expression (59).

$$\begin{matrix}[ Mathematical Expression 10 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] >> 5 \\ with x , y = 0 , … , 15 & ( 59 )\end{matrix}$$

Also, in the event that P(x,−1); x,y=−1, 0, . . . , 15 is “unavailable”, the prediction value Pred(x,y) of each of the pixels in the object macro block A is generated as in the following Expression (60).

$$\begin{matrix}[ Mathematical Expression 11 ] & \\ Pred ( x , y ) = [ {\sum }_{{y}^{′} = 0}^{15} P ( - 1 , {y}^{′} ) + 8 ] >> 4 \\ with x , y = 0 , … , 15 & ( 60 )\end{matrix}$$

In the event that P(−1,y); x,y=−1, 0, . . . , 15 is “unavailable”, the prediction value Pred(x,y) of each of the pixels in the object macro block A is generated as in the following Expression (61).

$$\begin{matrix}[ Mathematical Expression 12 ] & \\ Pred ( x , y ) = [ {\sum }_{{y}^{′} = 0}^{15} P ( {x}^{′} , - 1 ) + 8 ] >> 4 \\ with x , y = 0 , … , 15 & ( 61 )\end{matrix}$$

In the event that P(x,−1) and P(−1,y); x,y=−1, 0, . . . , 15 as all “unavailable”, 128 is used as a prediction pixel value.

Mode 3 is the Plane Prediction mode, and is applied only in the event that P(x,−1 and P(−1,y); x,y=−1, 0, . . . , 15 are all “available”. In this case, the prediction value Pred(x,y) of each of the pixels in the object macro block A is generated as in the following Expression (62).

$$\begin{matrix}[ Mathematical Expression 13 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) & ( 62 )\end{matrix}$$

Next, the intra prediction modes as to color difference signals will be described. FIG. 17 is a diagram illustrating the four types of color difference signal intra prediction modes (Intra_chroma_pred_mode). The color difference signal intra prediction mode can be set independently from the luminance signal intra prediction mode. The intra prediction mode for color difference signals conforms to the above-described luminance signal 16×16 pixel intra prediction mode.

Note however, that while the luminance signal 16×16 pixel intra prediction mode handles 16×16 pixel blocks, the intra prediction mode for color difference signals handles 8×8 pixel blocks. Further, the node Nos. do not correspond between the two, as can be seen in FIG. 14 and FIG. 17 described above.

In accordance with the definition of pixel values of the macro block which the object of the luminance signal 16×16 pixel intra prediction mode and the adjacent pixel values described above with reference to FIG. 16, the pixel values adjacent to the macro block A for intra processing (8×8 pixels in the case of color difference signals) will be taken as P(x,y);x,y=−1, 0, . . . , 7.

Mode 0 is the DC Prediction mode, and in the event that P(x,−1) and P(−1,y); x,y=−1, 0, . . . , 7 are all “available”, the prediction pixel value Pred(x,y) of each of the pixels of the object macro block A is generated as in the following Expression (63).

$$\begin{matrix}[ Mathematical Expression 14 ] & \\ Pred ( x , y ) = ( ( {\sum }_{n = 0}^{7} ( P ( - 1 , n ) + P ( n , - 1 ) ) ) + 8 ) >> 4 \\ with x , y = 0 , … , 7 & ( 63 )\end{matrix}$$

Also, in the event that P(−1,y); x,y=−1, 0, . . . , 7 is “unavailable”, the prediction pixel value Pred(x,y) of each of the pixels of object macro block A is generated as in the following Expression (64).

$$\begin{matrix}[ Mathematical Expression 15 ] & \\ Pred ( x , y ) = [ ( {\sum }_{n = 0}^{7} P ( n , - 1 ) ) + 4 ] >> 3 \\ with x , y = 0 , … , 7 & ( 64 )\end{matrix}$$

Also, in the event that P(x,−1); x,y=−1, 0, . . . , 7 is “unavailable”, the prediction pixel value Pred(x,y) of each of the pixels of object macro block A is generated as in the following Expression (65).

$$\begin{matrix}[ Mathematical Expression 16 ] & \\ Pred ( x , y ) = [ ( {\sum }_{n = 0}^{7} P ( - 1 , n ) ) + 4 ] >> 3 \\ with x , y = 0 , … , 7 & ( 65 )\end{matrix}$$

Mode 1 is the Horizontal Prediction mode, and is applied only in the event that P(−1,y); x,y=−1, 0, . . . , 7 is “available”. In this case, the prediction pixel value Pred(x,y) of each of the pixels of object macro block A is generated as in the following Expression (66).

Pred(x,y)=P(−1,y); x,y=0, . . . , 7 (66)

Mode 2 is the Vertical Prediction mode, and is applied only in the event that P(x,−1); x,y=−1, 0, . . . , 7 is “available”. In this case, the prediction pixel value Pred(x,y) of each of the pixels of object macro block A is generated as in the following Expression (67).

Pred(x,y)=P(x,−1); x,y=0, . . . , 7 (67)

Mode 3 is the Plane Prediction mode, and is applied only in the event that P(x,−1) and P(−1,y); x,y=−1, 0, . . . , 7 are “available” In this case, the prediction pixel value Pred(x,y) of each of the pixels of object macro block A is generated as in the following Expression (68).

$$\begin{matrix}[ Mathematical Expression 17 ] & \\ Pred ( x , y ) = Clip 1 ( a + b \cdot ( x - 3 ) + c \cdot ( y - 3 ) + 16 ) >> 5 ; \\ x , y = 0 , … 7 \\ a = 16 \cdot ( P ( - 1 , 7 ) + P ( 7 , - 1 ) ) \\ b = ( 17 \cdot H + 16 ) >> 5 \\ c = ( 17 \cdot V + 16 ) >> 5 \\ H = {\sum }_{x = 1}^{4} x \cdot [ P ( 3 + x , - 1 ) - P ( 3 - x , - 1 ) ] \\ V = {\sum }_{y = 1}^{4} y \cdot [ P ( - 1 , 3 + y ) - P ( - 1 , 3 - y ) ] & ( 68 )\end{matrix}$$

As described above, there are nine types of 4×4 pixel and 8×8 pixel block-increment and four types of 16×16 pixel macro block-increment prediction modes for luminance signal intra prediction modes, and there are four types of 8×8 pixel block-increment prediction modes for color difference signal intra prediction modes. The color difference intra prediction mode can be set separately from the luminance signal intra prediction mode. For the luminance signal 4×4 pixel and 8×8 pixel intra prediction modes, one intra prediction mode is defined for each 4×4 pixel and 8×8 pixel luminance signal block. For luminance signal 16×16 pixel intra prediction modes and color difference intra prediction modes, one prediction mode is defined for each macro block.

Note that the types of prediction modes correspond to the directions indicated by the Nos. 0, 1, 3 through 8, in FIG. 9 described above. Prediction mode 2 is an average value prediction.

Next, the intra prediction processing in step S31 of FIG. 5, which is processing performed as to these intra prediction modes, will be described with reference to the flowchart in FIG. 18. Note that in the example in FIG. 18, the case of luminance signals will be described as an example.

In step S41, the intra prediction unit 74 performs intra prediction as to each intra prediction mode of 4×4 pixels, 8×8 pixels, and 16×16 pixels, for luminance signals, described above.

For example, the case of 4×4 pixel intra prediction mode will be described with reference to FIG. 10 described above. In the event that the image to be processed that has been read out from the screen rearranging buffer 62 (e.g., pixels a through p), is a block image to be subjected to intra processing, a decoded image to be reference (pixels indicated by pixel values A through M) is read out from the frame memory 72, and supplied to the intra prediction unit 74 via the switch 73.

Based on these images, the intra prediction unit 74 performs intra prediction of the pixels of the block to be processed. Performing this intra prediction processing in each intra prediction mode results in a prediction image being generated in each intra prediction mode. Note that pixels not subject to deblocking filtering by the deblocking filter 71 are used as the decoded signals to be referenced (pixels indicated by pixel values A through M).

In step S42, the intra prediction unit 74 calculates cost function values for each intra prediction mode of 4×4 pixels, 8×8 pixels, and 16×16 pixels. Now, one technique of either a High Complexity mode or a Low Complexity mode is used for calculation of cost function values, as stipulated in JM (Joint Model) which is reference software in the H.264/AVC format.

That is to say, with the High Complexity mode, as far as temporary encoding processing is performed for all candidate prediction modes as the processing of step S41, a cost function value is calculated for each prediction mode as shown in the following Expression (69), and the prediction mode which yields the smallest value is selected as the optimal prediction mode.

Cost(Mode)=D+λ·R (69)

D is difference (noise) between the original image and decoded image, R is generated code amount including orthogonal transform coefficients, and λ is a Lagrange multiplier given as a function of a quantization parameter QP.

On the other hand, in the Low Complexity mode, as for the processing of step S41, prediction images are generated and calculation is performed as far as the header bits such as motion vector information and prediction mode information, for all candidates prediction modes, a cost function value shown in the following Expression (70) is calculated for each prediction mode, and the prediction mode yielding the smallest value is selected as the optimal prediction mode.

Cost(Mode)=D+QPtoQuant(QP)·Header_Bit (70)

D is difference (noise) between the original image and decoded image, Header_Bit is header bits for the prediction mode, and QPtoQuant is a function given as a function of a quantization parameter QP.

In the Low Complexity mode, just a prediction image is generated for all prediction modes, and there is no need to perform encoding processing and decoding processing, so the amount of computation that has to be performed is small.

In step S43, the intra prediction unit 74 determines an optimal mode for each intra prediction mode of 4×4 pixels, 8×8 pixels, and 16×16 pixels. That is to say, as described above with reference to FIG. 9, there are nine types of prediction modes for intra 4×4 pixel prediction mode and intra 8×8 pixel prediction mode, and there are four types of prediction modes for intra 16×16 pixel prediction mode. Accordingly, the intra prediction unit 74 determines from these an optimal intra 4×4 pixel prediction mode, an optimal intra 8×8 pixel prediction mode, and an optimal intra 16×16 pixel prediction mode.

In step S44, the intra prediction unit 74 selects one intra prediction mode from the optimal modes selected for each intra prediction mode of 4×4 pixels, 8×8 pixels, and 16×16 pixels, based on the cost function value calculated in step S42. That is to say, the intra prediction mode of which the cost function value is the smallest is selected from the optimal modes decided for each intra prediction mode of 4×4 pixels, 8×8 pixels, and 16×16 pixels.

Next, the inter motion prediction processing in step S32 in FIG. 5 will be described with reference to the flowchart in FIG. 19.

In step S51, the motion prediction/compensation unit 77 determines a motion vector and reference information for each of the eight types of inter prediction modes made up of 16×16 pixels through 4×4 pixels, described above with reference to FIG. 2. That is to say, a motion vector and reference image is determined for a block to be processed with each inter prediction mode.

In step S52, the motion prediction/compensation unit 77 performs motion prediction and compensation processing for the reference image, based on the motion vector determined in step S51, for each of the eight types of inter prediction modes made up of 16×16 pixels through 4×4 pixels. As a result of this motion prediction and compensation processing, a prediction image is generated in each inter prediction mode.

In step S53, the motion prediction/compensation unit 77 generates motion vector image to be added to a compressed image, based on the motion vector determined as to the eight types of inter prediction modes made up of 16×16 pixels through 4×4 pixels.

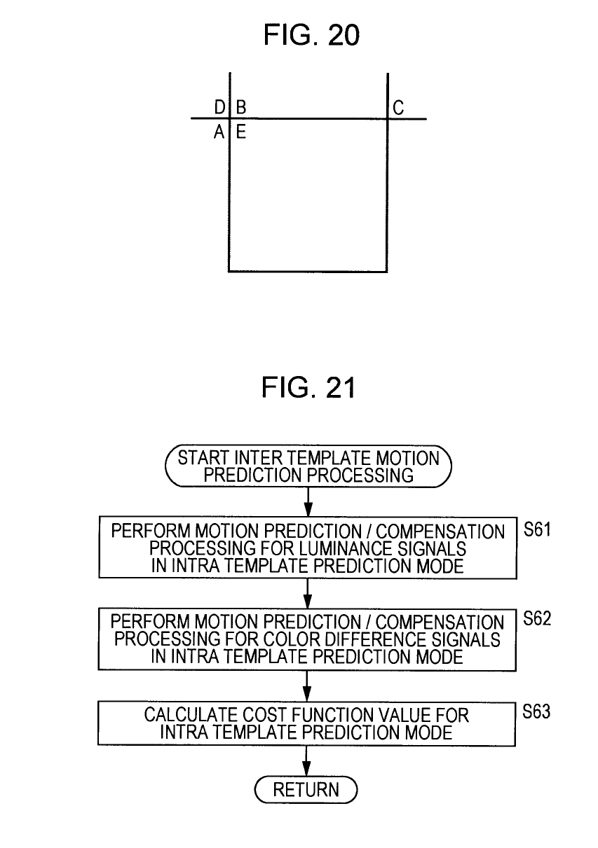

Now, a motion vector information generating method with the H.264/AVC format will be described with reference to FIG. 20. The example in FIG. 20 shows an object block E to be encoded (e.g., 16×16 pixels), and blocks A through D which have already been encoded and are adjacent to the object block E.

That is to say, the block D is situated to the upper left of the object block E, the block B is situated above the object block E, the block C is situated to the upper right of the object block E, and the block A is situated to the left of the object block E. Note that the reason why blocks A through D are not sectioned off is to express that they are blocks of one of the configurations of 16×16 pixels through 4×4 pixels, described above with FIG. 2.

For example, let us express motion vector information as to X (=A, B, C, D, E) as mvₓ. First, prediction motion vector information (prediction value of motion vector) pmv_{E} as to the block E is generated as shown in the following Expression (71), using motion vector information relating to the blocks A, B, and C.

pmv_{E}=med(mv_{A},mv_{B},mv_{c}) (71)

In the event that the motion vector information relating to the block C is not available (is unavailable) due to a reason such as being at the edge of the image frame, or not being encoded yet, the motion vector information relating to block D is substituted instead of the motion vector information relating to block C.

Data mvd_{E} to be added to the header portion of the compressed image, as motion vector information as to the object block E, is generated as shown in the following Expression (72), using pmv_{E}.

mvd_{E}=mv_{E}−pmv_{E} (72)

Note that in actual practice, processing is performed independently for each component of the horizontal direction and vertical direction of the motion vector information.

Thus, motion vector information can be reduced by generating prediction motion vector information, and adding the difference between the prediction motion vector information generated from correlation with adjacent blocks and the motion vector information to the header portion of the compressed image.

The motion vector information generated in this way is also used for calculating cost function values in the following step S54, and in the event that a corresponding prediction image is ultimately selected by the prediction image selecting unit 80, this is output to the lossless encoding unit 66 along with the mode information and reference frame information.

Returning to FIG. 19, in step S54 the motion prediction/compensation unit 77 calculates the cost function values shown in Expression (69) or Expression (70) described above, for each inter prediction mode of the eight types of inter prediction modes made up of 16×16 pixels through 4×4 pixels. The cost function values calculated here are used at the time of determining the optimal inter prediction mode in step S36 in FIG. 5 described above.

Note that calculation of the cost function values as to the inter prediction modes includes evaluation of cost function values in Skip Mode and Direct Mode, stipulated in the H.264/AVC format.

Next, the intra template prediction processing in step S33 of FIG. 5 will be described with reference to the flowchart in FIG. 21.

In step S61, the luminance intra TP motion prediction/compensation unit 75 performs motion prediction/compensation processing for luminance signals in the intra template prediction mode. That is to say, based on the intra template matching method, the luminance intra TP motion prediction/compensation unit 75 searches for a motion vector as to the luminance signals, and generates a prediction image based on the motion vector. At this time, the searched motion vector information for the luminance signals is supplied to the color difference intra TP motion prediction/compensation unit 76 along with the image for intra prediction that has been read out from the screen rearranging buffer 62 and the reference image supplied from the frame memory 72.

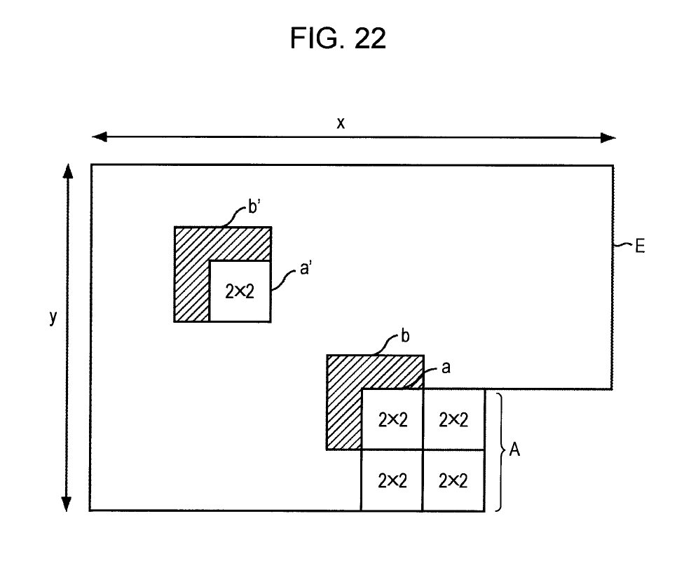

Now, the intra template matching method will be described in detail with reference to FIG. 22.

In the example in FIG. 22, a block A of 4×4 pixels, and a predetermined search range configured of already-encoded pixels within a range made up of X×Y (=vertical×horizontal) pixels, are shown on an unshown object frame to be encoded.

An object sub-block a which is to be encoded from now is shown in the block A. This object sub-block a is the sub-block at the upper left of the 2×2 pixel sub-blocks making up the block A. A template region b, which is made up of pixels that have already been encoded, is adjacent to the object sub-block a. That is to say, in the event of performing encoding processing in raster scan order, the template region b is a region situated at the left and upper side of the object sub-block a as shown in FIG. 22, and is a region regarding which the decoded image is accumulated in the frame memory 72.

The luminance intra TP motion prediction/compensation unit 75 performs template matching with SAD (Sum of Absolute Difference) or the like for example, as the cost function value, within a predetermined search range E on the object frame, and searches for a region b′ wherein the correlation with the pixel values of the template region b is the highest. The luminance intra TP motion prediction/compensation unit 75 then takes a block a′ corresponding to the found region b′ as a prediction image as to the object sub-block a, and searches for a motion vector corresponding to the object block a.

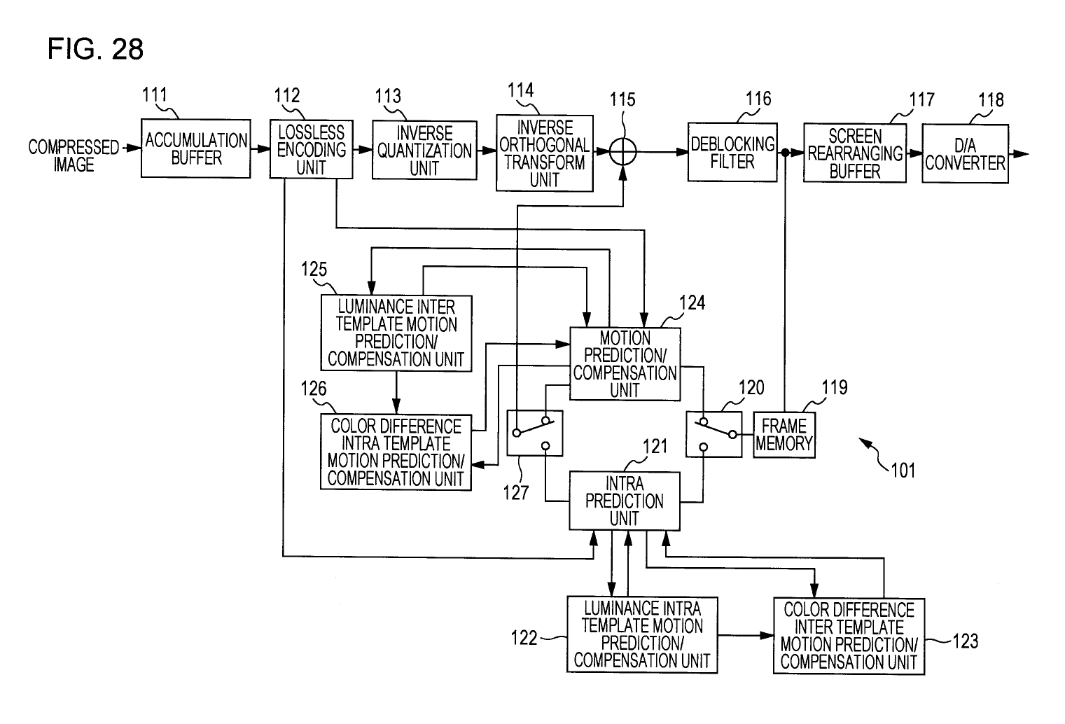

As described here, with the motion vector search processing using the intra template matching method, a decoded image is used for the template matching processing, so the same processing can be performed with the image encoding device 51 in FIG. 1 and a later-described image decoding device 101 in FIG. 28 by setting a predetermined search range E beforehand. That is to say, with the image decoding device 101 as well, configuring a luminance intra TP motion prediction/compensation unit 122 does away with the need to send motion vector information regarding the object sub-block to the image decoding device 101, so motion vector information in the compressed image can be reduced. While description will be omitted, this is the same for the case of color difference signals as well.

While a case of an object sub-block of 2×2 pixels has been described in FIG. 22, this is not restrictive, rather, sub-blocks of optional sizes can be applied, and the size of blocks and templates in the intra template prediction mode are optional. That is to say, as with the case of the intra prediction unit 74, the intra template prediction mode can be carried out with block sizes of each intra prediction mode as candidates, or can be carried out fixed to one prediction mode block size. The template size may be variable or may be fixed as to the object block size.

In step S62, the color difference intra TP motion prediction/compensation unit 76 performs motion prediction/compensation processing for color difference signals in the intra template prediction mode. That is to say, the color difference intra TP motion prediction/compensation unit 76 searches for the a motion vector as to the color difference signals based on the intra template matching method, and generates a prediction image based on the motion vector. At this time, the color difference intra TP motion prediction/compensation unit 76 obtains the center of the search using the motion vector information searched by the luminance intra TP motion prediction/compensation unit 75, and performs motion prediction within a predetermined search range with that as the center.

Note that the block size and template size for processing as to the color difference signals may be the same as the block size and template size for luminance signals, or may be different.

Also, with the intra template matching method, quarter-pixel precision motion prediction/compensation processing using 6-tap FIR is performed on luminance signals as described above with reference to FIG. 3, but ⅛-pixel precision motion prediction/compensation processing is performed with linear interpolation for color difference signals.

However, performing ⅛-pixel precision motion prediction/compensation processing on all candidate pixel values would require massive computation amounts. Accordingly, at the color difference intra TP motion prediction/compensation unit 76, first, integer-pixel precision motion prediction/compensation processing is performed, and around optimal motion vector information obtained thereby is subjected to half-pixel precision motion prediction/compensation processing. Also, around optimal motion vector information obtained by the half-pixel precision motion prediction/compensation processing is subjected to quarter-pixel precision motion prediction/compensation processing, and further, around optimal motion vector information obtained thereby is subjected to ⅛-pixel precision motion prediction/compensation processing.

Note however, that performing intra template matching method motion prediction/compensation processing independently of the color difference signals leads to increased computation amounts at the image encoding device 51 in FIG. 1 and the image decoding device 101 in FIG. 28.

Accordingly, at the time of performing the intra template matching method motion prediction/compensation processing, the color difference intra TP motion prediction/compensation unit 76 obtains the center of searching using the motion vector information searched by the luminance intra TP motion prediction/compensation unit 75, and performs motion prediction in a predetermined search range with that as the center of the search.

To describe in detail, first, we will say that intra template prediction mode motion prediction/compensation processing for luminance signals is performed at the luminance intra TP motion prediction/compensation unit 75 as to a block of (2n, 2m) pixels in size, whereby motion vector information (MVTMₕ, MVTMᵥ) is obtained.

Now, we will define rₕ and rᵥ as in the following Expression (73), in accordance to the chroma format of the image signals.

$$\begin{matrix}[ Mathematical Expression 18 ] & \\ {r}_{h} = \{ \begin{matrix}2 ( Case of 4 \text{:} 2 \text{:} 0 ) \\ 2 ( Case of 4 \text{:} 2 \text{:} 2 ) \\ 1 ( Case of 4 \text{:} 4 \text{:} 4 )\end{matrix} \\ {r}_{v} = \{ \begin{matrix}2 ( Case of 4 \text{:} 2 \text{:} 0 ) \\ 1 ( Case of 4 \text{:} 2 \text{:} 2 ) \\ 1 ( Case of 4 \text{:} 4 \text{:} 4 )\end{matrix} & ( 73 )\end{matrix}$$

At this time, the color difference intra TP motion prediction/compensation unit 76 takes the center of the search as (MVTMₕ/rₕ, MVTMᵥ/rᵥ) in increments of blocks of (2n/rₕ, 2m/rᵥ) pixels in size, searches the several pixels therearound, and performs motion prediction. Thus, reduction in computation amount can be realized while keeping deterioration in encoding efficiency to a minimum.

Note that fractions from division are rounded so that the center of the search is of integer-pixel precision in the color difference signals. Also, at this time, the template size may be the same for the luminance signals and color difference signals, or may be a value converted by (rₕ, rᵥ). Further, template matching processing using template sizes separately determined for luminance signals and color difference signals may be performed.

Also, the intra template prediction mode motion prediction/compensation processing may be performed to each of Cb/Cr, or intra template prediction mode motion prediction/compensation processing may be performed based on cost function values such as difference signals or the like with Cb and Cr together.

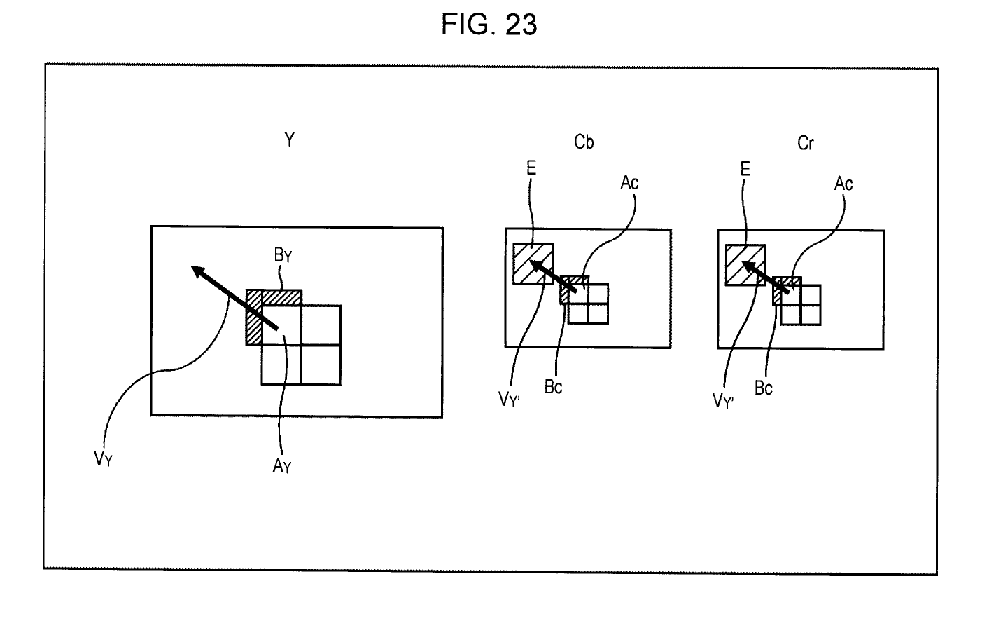

FIG. 23 is a diagram for describing motion prediction/compensation processing for color difference signals in the intra template prediction mode described above. We will say that the input image signals are of the 4:2:0 format. The example shown in FIG. 23 shows intra template prediction mode motion prediction/compensation processing for each of luminance signals Y, color difference signals Cb, and color difference signals Cr, from the left.

For example, with the luminance intra TP motion prediction/compensation unit 75, we will say that a template region B_{Y} adjacent to a luminance block A_{Y} of 4×4 pixels and made up of encoded pixels is used as to the luminance block A_{Y}, whereby intra template prediction mode motion prediction/compensation processing is performed as to the luminance signals, thereby obtaining motion vector information V_{Y}.

At this time, the color difference intra TP motion prediction/compensation unit 76 obtains motion vector information V_{Y}′ where the motion vector information V_{Y} has been scaled, and takes a range E from the surrounding pixels with this as the center as the search range. The color difference intra TP motion prediction/compensation unit 76 performs motion prediction from the range E, regarding the color difference signals Cb and Cr, on a color difference block A_{C} of 2×2 pixels using a template region B_{C} which is made up of encoded pixels and is adjacent to the color difference block A_{C}. Accordingly, reduction in computation amount can be realized while keeping deterioration in encoding efficiency to a minimum.

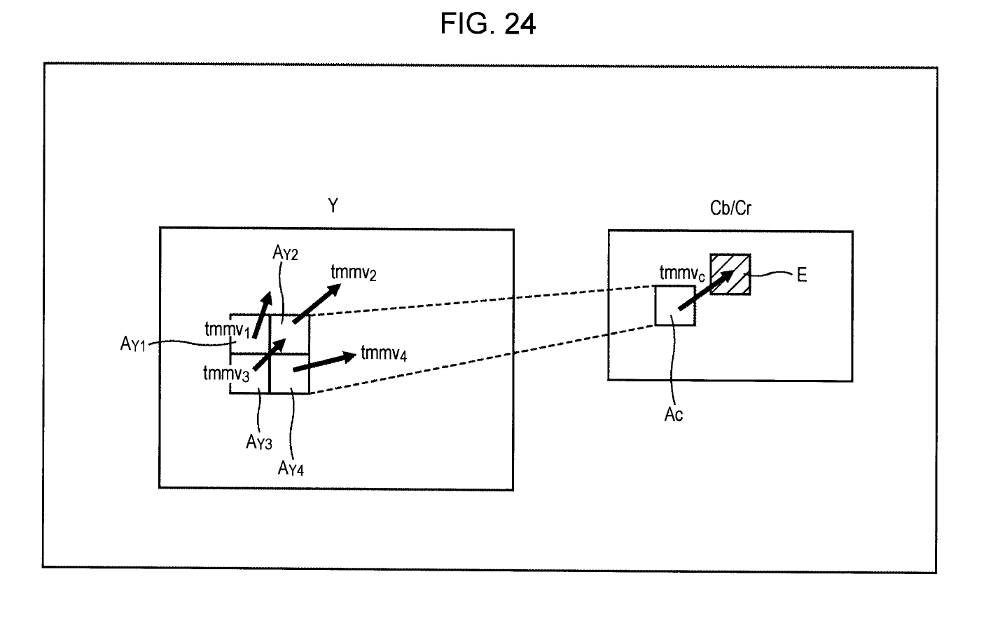

FIG. 24 is a diagram describing another example of the above-described intra template prediction mode motion prediction/compensation processing. We will say that the input image signals are of the 4:2:0 format. The example shown in FIG. 24 shows intra template prediction mode motion prediction/compensation processing for each of luminance signals Y, and color difference signals Cb/Cr, from the left.

For example, with the luminance intra TP motion prediction/compensation unit 75, we will say that intra template prediction mode motion prediction/compensation processing for luminance signals is performed on each of four luminance blocks A_{Y1}, A_{Y2}, A_{Y3}, and A_{Y4}, of 4×4 pixels, thereby obtaining motion vector information tmmv₁, tmmv₂, tmmv₃, and tmmv₄, respectively.

At this time, the color difference intra TP motion prediction/compensation unit 76 obtains a representative value tmmv_{C} from the motion vector information tmmv₁, tmmv₂, tmmv₃, and tmmv₄, and takes a range E from the surrounding pixels with this as the center as the search range. The color difference intra TP motion prediction/compensation unit 76 performs motion prediction from the range E, regarding the color difference signals Cb and Cr, on a color difference block A_{C} of 4×4 pixels using a template region (unshown) which is made up of encoded pixels and is adjacent to the color difference block A_{C}.

Note that the representative value tmmv_{c} is obtained by processing such as average value, as shown in Expression (74), for example.

[Mathematical Expression 19]

tmmv_{C}=f(tmmv₁,tmmv₂,tmmv₃,tmmv₄) (74)

Note that the representative value is not restricted to an average value, and may be obtained by other processing such as median, as long as it is a representative value obtained from the motion vector information tmmv₁, tmmv₂, tmmv₃, and tmmv₄.

Returning to FIG. 21, the prediction image for color difference signals generated in step S62 is supplied to the luminance intra TP motion prediction/compensation unit 75. The prediction image generated by the luminance and color difference intra template prediction mode motion prediction/compensation processing is supplied to an intra prediction unit 121.

In step S63, the luminance intra TP motion prediction/compensation unit 75 calculates the cost function values shown in Expression (69) or Expression (70) described above, for the intra template prediction mode. The cost function values calculated here are used for determining the optimal intra prediction mode in step S34 in FIG. 5 described above.

Next, the inter template prediction processing in step S35 in FIG. 5 will be described with reference to the flowchart in FIG. 25.

In step S71, the luminance inter TP motion prediction/compensation unit 78 performs motion prediction/compensation processing for luminance signals in the inter template prediction mode. That is to say, the luminance inter TP motion prediction/compensation unit 78 searches for a motion vector for luminance signals based on the inter template matching method, and generates a prediction image based on the motion vector. At this time, the luminance signal motion vector information that has been found is supplied to the color difference inter TP motion prediction/compensation unit 79 along with the image for inter prediction that has been read out from the screen rearranging buffer 62 and the reference image supplied from the frame memory 72.

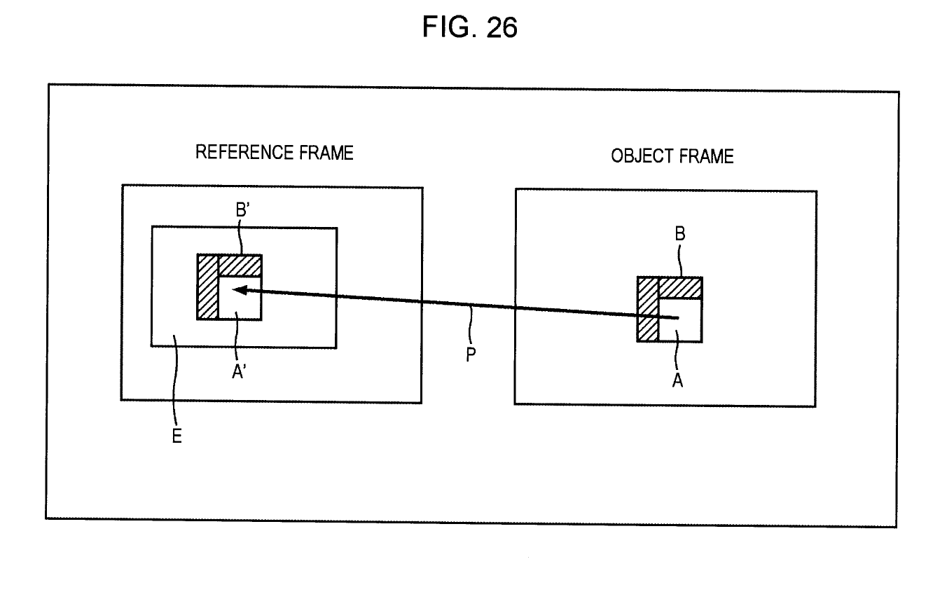

Now, the inter template matching method will be described in detail with reference to FIG. 26.

In the example in FIG. 26, an object frame to be encoded, and a reference frame referenced at the time of searching for a motion vector, are shown. In the object frame are shown an object block A which is to be encoded from now, and a template region B which is adjacent to the object block A and is made up of already-encoded pixels. That is to say, the template region B is a region to the left and the upper side of the object block A when performing encoding in raster scan order, as shown in FIG. 26, and is a region where the decoded image is accumulated in the frame memory 72.

The luminance inter TP motion prediction/compensation unit 78 performs template matching on the luminance signals with SAD (Sum of Absolute Difference) or the like for example, as the cost function value, within a predetermined search range E on the object frame, and searches for a region B′ wherein the correlation with the pixel values of the template region B is the highest. The luminance inter TP motion prediction/compensation unit 78 then takes a block A′ corresponding to the found region B′ as a prediction image as to the object block A, and searches for a motion vector P corresponding to the object block A.

As described here, with the motion vector search processing using the inter template matching method, a decoded image is used for the template matching processing, so the same processing can be performed with the image encoding device 51 in FIG. 1 and a later-described image decoding device 101 in FIG. 28 by setting a predetermined search range E beforehand. That is to say, with the image decoding device 101 as well, configuring a luminance inter TP motion prediction/compensation unit 125 does away with the need to send motion vector information regarding the object sub-block to the image decoding device 101, so motion vector information in the compressed image can be reduced. While description will be omitted, this is the same for the case of color difference signals as well.

Note that the size of blocks and templates in the inter template prediction mode are optional. That is to say, as with the case of the motion prediction/compensation unit 77, the inter template prediction mode can be carried out with one block size fixed from the 16×16 pixels through 4×4 pixels described above with FIG. 2, or all block sizes may be taken as candidates. The template size may be fixed or may be variable as to the block size.

In step S72, the color difference inter TP motion prediction/compensation unit 79 performs inter template prediction mode color difference signal motion prediction/compensation processing. That is to say, the color difference inter TP motion prediction/compensation unit 79 searches for a motion vector as to the color difference signals based on the inter template matching method, and generates prediction images based on the motion vector.

The prediction image generated by motion prediction/compensation processing in the color difference inter template prediction mode is supplied to the luminance inter TP motion prediction/compensation unit 78. The prediction image generated by the motion prediction/compensation processing in the luminance and color difference inter template prediction modes is supplied to the motion prediction/compensation unit 77.

Note that at the time of motion prediction in step S72, the color difference inter TP motion prediction/compensation unit 79 obtains the center of searching using the motion vector information found by the luminance inter TP motion prediction/compensation unit 78, and performs motion prediction within the predetermined search range with this as the center of searching, in the same way as with the intra template prediction mode described above with reference to FIG. 23 and FIG. 24.

Note however, in the case of inter template matching, there is the need to take handling of multi-reference frames (Multi-Reference Frame) into consideration.

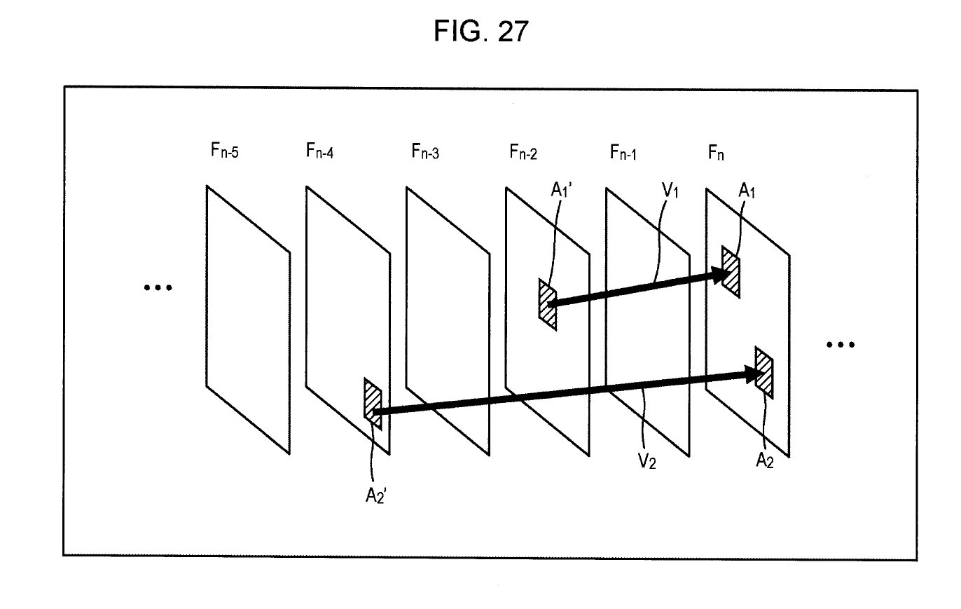

Now, the motion prediction/compensation method of multi-reference frames stipulated in the H.264/AVC format will be described with reference to FIG. 27.

In the example in FIG. 27, an object frame Fₙ to be encoded from now, and already-encoded frames Fₙ₋₅, . . . , Fₙ₋₁, are shown. The frame Fₙ₋₁ is a frame one before the object frame Fₙ, the frame Fₙ₋₂ is a frame two before the object frame Fₙ, and the frame Fₙ₋₃ is a frame three before the object frame Fₙ. Also, the frame Fₙ₋₄ is a frame four before the object frame Fₙ, and the frame Fₙ₋₅ is a frame five before the object frame Fₙ. The closer the frame is to the object frame, the smaller the index (also called reference frame No.) the frame is. That is to say, the index is smaller in the order of Fₙ₋₁, . . . , Fₙ₋₅.

Block A₁ and block A₂ are displayed in the object frame Fₙ, with a motion vector V₁ having been found due to correlation with a block A₁′ in the frame Fₙ₋₂ two back. Also, a motion vector V₂ has been found for block A₂ due to correlation with a block A₁′ in the frame Fₙ₋₄ four back.

That is to say, with MPEG2, the only P picture which could be referenced is the immediately-previous frame Fₙ₋₁, but with the H.264/AVC format, multiple reference frames can be held, and reference frame information independent for each block can be had, such as the block A₁ referencing the Fₙ₋₂ and the block A₁ referencing the Fₙ₋₄.

However, performing motion prediction with the inter template matching method for all reference frames which are candidates for multi-reference frames with regard to color difference signals, separately from luminance signals, would lead to increased computation amount.

Accordingly, we will say that in the motion prediction processing with the inter template matching method relating to color difference signals, only reference frames found by the motion prediction processing with the inter template matching method as to the corresponding luminance signal blocks will be searched.

Note however, that as shown in FIG. 24, in the event of performing motion prediction processing with template matching for a single color difference block corresponding to multiple luminance blocks, the corresponding luminance block with the smallest index is taken as the reference frame for the color difference block.

Note that the block size and template size for the color difference signals may be the same as the block size and template size for the luminance signals, or may be different.

As described above, motion prediction/compensation processing can be performed with the template matching method for color difference signals separate from luminance signals, whereby encoding efficiency can be improved.

Also, in the event of performing motion prediction in the template prediction mode with regard to color difference signals, motion vector searching is performed within the a predetermined search range around motion vector information searched by motion prediction with the template prediction mode with regard to luminance signals, so the amount of computation can be reduced.

A decoded compressed image is transmitted via a predetermined transmission path, and is decoded by the image decoding device.

FIG. 28 illustrates the configuration of an embodiment of an image decoding device serving as an image processing to device to which the present invention has been applied.

An image decoding device 101 is configured of an accumulation buffer 111, a lossless decoding unit 112, a quantization unit 113, an inverse orthogonal transform unit 114, a computing unit 115, a deblocking filter 116, a screen rearranging buffer 117, a D/A converter 118, frame memory 119, a switch 120, a intra prediction unit 121, a luminance intra template motion prediction/compensation unit 122, a color difference intra template motion prediction/compensation unit 123, a motion prediction/compensation unit 124, a luminance inter template motion prediction/compensation unit 125, a color difference inter template motion prediction/compensation unit 126, and a switch 127.

Note that in the following, the luminance intra template motion prediction/compensation unit 122 and color difference intra template motion prediction/compensation unit 123 will be referred to as luminance intra TP motion prediction/compensation unit 122 and color difference intra TP motion prediction/compensation unit 123, respectively. Also, the luminance inter template motion prediction/compensation unit 125 and color difference inter template motion prediction/compensation unit 126 will be referred to as luminance inter TP motion prediction/compensation unit 125 and color difference inter TP motion prediction/compensation unit 126, respectively.

The accumulation buffer 111 accumulates compressed images transmitted thereto. The lossless decoding unit 112 decodes information encoded by the lossless encoding unit 66 that has been supplied from the accumulation buffer 111, with a format corresponding to the encoding format of the lossless encoding unit 66. The inverse quantization unit 113 performs inverse quantization of the image decoded by the lossless decoding unit 112, with a format corresponding to the quantization format of the quantization unit 65 in FIG. 1. The inverse orthogonal transform unit 114 performs inverse orthogonal transform of the output of the inverse quantization unit 113, with a format corresponding to the inverse orthogonal transform format of the orthogonal transform unit 64 in FIG. 1.

The output of inverse orthogonal transform is added by the computing unit 115 with a prediction image supplied from the switch 127. The deblocking filter 116 removes block noise in the decoded image, supplies to the frame memory 119 so as to be accumulated, and outputs to the inverse orthogonal transform screen rearranging buffer 117.

The screen rearranging buffer 117 performs rearranging of images. That is to say, the order of frames rearranged by the screen rearranging buffer 62 in FIG. 1 in the order for encoding, is rearranged to the original display order. The D/A converter 118 performs D/A conversion of images output from the screen rearranging buffer 117, and outputs to an unshown display for display.

The switch 120 reads out the image to be subjected to inter encoding and the image to be referenced from the frame memory 119, and outputs to the motion prediction/compensation unit 124, and also reads out the image to be used for intra prediction, and supplies to the intra prediction unit 121.

Information relating to the intra prediction mode obtained by decoding header information is supplied to the intra prediction unit 121 from the lossless decoding unit 112. In the event that information is supplied to the effect of the intra prediction mode, the intra prediction unit 121 generates a prediction image based on this information. In the event that information is supplied to the effect of the intra template prediction mode, the intra prediction unit 121 supplies the image to be used for intra prediction to the luminance intra TP motion prediction/compensation unit 122, for motion prediction/compensation processing to be performed in the intra template prediction mode.

The intra prediction unit 121 outputs a generated prediction image, or a prediction image generated by the luminance intra TP motion prediction/compensation unit 122, to the switch 127.

The luminance intra TP motion prediction/compensation unit 122 performs motion prediction/compensation processing of the intra template prediction mode, the same as with the luminance intra TP motion prediction/compensation unit 75 in FIG. 1. That is to say, the luminance intra TP motion prediction/compensation unit 122 performs motion prediction/compensation processing of luminance signals in the intra template prediction mode, based on an image for intra prediction read out from the frame memory 119, and generates a prediction image of luminance signals. The prediction image generated by the luminance intra template prediction mode motion prediction/compensation processing is supplied to the intra prediction unit 121.

The luminance intra TP motion prediction/compensation unit 122 supplies the image for intra prediction read out from the frame memory 119 and the motion vector information searched for in the motion prediction/compensation processing of the luminance signals, to the color difference intra TP motion prediction/compensation unit 123.

The color difference intra TP motion prediction/compensation unit 123 performs motion prediction/compensation processing of luminance signals in the intra template prediction mode, the same as with the color difference intra TP motion prediction/compensation unit 76 in FIG. 1. That is to say, the color difference intra TP motion prediction/compensation unit 123 performs motion prediction/compensation processing of color difference signals in the intra template prediction mode, based on the image for intra prediction read out from the frame memory 119, and generates a prediction image of color difference signals. At this time, the color difference intra TP motion prediction/compensation unit 123 obtains the center of searching using the motion vector information searched by the luminance intra TP motion prediction/compensation unit 122, and performs motion prediction within a predetermined search range with this as the center of searching.

The color difference intra TP motion prediction/compensation unit 123 supplies the generated prediction image to the luminance intra TP motion prediction/compensation unit 122.

Information obtained by decoding the header information (prediction mode, motion vector information, reference frame information) is supplied from the lossless decoding unit 112 to the motion prediction/compensation unit 124. In the event that information which is inter prediction mode is supplied, the motion prediction/compensation unit 124 subjects the image to motion prediction and compensation processing based on the motion vector information and reference frame information, and generates a prediction image. In the event that information is supplied which is inter template prediction mode, the motion prediction/compensation unit 124 supplies the image to which inter encoding is to be performed that has been read out from the frame memory 119 and image to be referenced, to the luminance inter TP motion prediction/compensation unit 125, so that motion prediction/compensation processing is performed in the inter template prediction mode.

Also, the motion prediction/compensation unit 124 outputs one of the prediction image generated with the inter prediction mode or the prediction image generated with the inter template prediction modem to the switch 127.

The luminance inter TP motion prediction/compensation unit 125 performs motion prediction and compensation processing for luminance signals in the inter template prediction mode, the same as the luminance inter TP motion prediction/compensation unit 78 in FIG. 1. That is to say, the luminance inter TP motion prediction/compensation unit 125 performs motion prediction and compensation processing in the inter template prediction mode based on the image to which inter encoding is to be performed that has been read out from the frame memory 119 and the image to be referenced, and generates a luminance signal prediction image. The prediction generated by the inter template prediction mode motion prediction/compensation processing is supplied to the motion prediction/compensation unit 124.

The luminance inter TP motion prediction/compensation unit 125 supplies the image to which inter encoding is to be performed that has been read out from the frame memory 119, and vector information found in the motion prediction and compensation processing of the luminance signals, to the color difference inter TP motion prediction/compensation unit 126.

The color difference inter TP motion prediction/compensation unit 126 performs motion prediction and compensation processing for color difference signals in the inter template prediction mode, the same as with the color difference inter TP motion prediction/compensation unit 79 in FIG. 1. That is, the color difference inter TP motion prediction/compensation unit 126 performs motion prediction and compensation processing for color difference signals in the inter template prediction mode, based on the image supplied from the frame memory 119, and generates a prediction image for color difference signals. At this time, the color difference inter TP motion prediction/compensation unit 126 obtains the center of searching using the motion vector information found by the luminance inter TP motion prediction/compensation unit 125, and performs motion prediction within the predetermined search range with this as the center of searching.

The color difference inter TP motion prediction/compensation unit 126 supplies the generated prediction image to the luminance inter TP motion prediction/compensation unit 125.

The switch 127 selects a prediction image generated by the motion prediction/compensation unit 124 or the intra prediction unit 121, and supplies this to the computing unit 115.

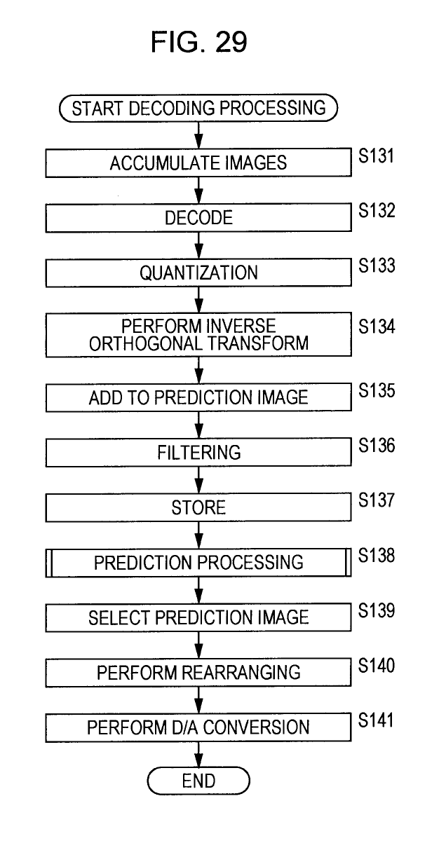

Next, the decoding processing which the image decoding device 101 executes will be described with reference to the flowchart in FIG. 29.

In step S131, the accumulation buffer 111 accumulates images transmitted thereto. In step S132, the lossless decoding unit 112 decodes compressed images supplied from the accumulation buffer 111. That is to say, the I picture, P pictures, and B pictures, encoded by the lossless encoding unit 66, are decoded.

At this time, motion vector information and prediction mode information (information representing intra prediction mode, intra template prediction mode, inter prediction mode, or inter template prediction mode) is also decoded. That is to say, in the event that the prediction mode information is the intra prediction mode or intra template prediction mode, the prediction mode information is supplied to the intra prediction unit 121. In the event that the prediction mode information is inter prediction mode or inter template prediction mode, the prediction mode information is supplied to the motion prediction/compensation unit 124. At this time, in the event that there is corresponding motion vector information or reference frame information, that is also supplied to the motion prediction/compensation unit 124.

In step S133, the inverse quantization unit 142 performs inverse quantization of the transform coefficients decoded at the lossless decoding unit 112, with properties corresponding to the properties of the quantization unit 65 in FIG. 1. In step S134, the inverse orthogonal transform unit 114 performs inverse orthogonal transform of the transform coefficients subjected to inverse quantization at the inverse quantization unit 142, with properties corresponding to the properties of the orthogonal transform unit 64 in FIG. 1. Accordingly, difference information corresponding to the input of the orthogonal transform unit 64 (output of the computing unit 63) in FIG. 1 has been decoded.

In step S135, the computing unit 115 adds to the difference information, a prediction image selected in later-described processing of step S139 and input via the switch 127. Thus, the original image is decoded. In step S136, the deblocking filter 116 performs filtering of the image output from the computing unit 115. Thus, block noise is eliminated. In step S137, the frame memory 119 stores the filtered image.

In step S138, the intra prediction unit 121, luminance intra TP motion prediction/compensation unit 122 and color difference intra TP motion prediction/compensation unit 123, motion prediction/compensation unit 124, or luminance inter TP motion prediction/compensation unit 125 and color difference inter TP motion prediction/compensation unit 126, each perform image prediction processing in accordance with the prediction mode information supplied from the lossless decoding unit 112.

That is to say, in the event that intra prediction mode information is supplied from the lossless decoding unit 112, the lossless decoding unit 112 performs intra prediction processing in the intra prediction mode. In the event that intra template prediction mode information is supplied from the lossless decoding unit 112, the luminance intra TP motion prediction/compensation unit 122 and color difference intra TP motion prediction/compensation unit 123 perform motion prediction/compensation processing in the intra template prediction mode. Also, in the event that inter prediction mode information is supplied from the lossless decoding unit 112, the motion prediction/compensation unit 124 performs motion prediction/compensation processing in the inter prediction mode. In the event that inter template prediction mode information is supplied from the lossless decoding unit 112, the luminance inter TP motion prediction/compensation unit 125 and color difference inter TP motion prediction/compensation unit 126 perform motion prediction/compensation processing in the inter template prediction mode.

While details of the prediction processing in step S138 will be described later, due to this processing, a prediction image generated by the intra prediction unit 121, a prediction image generated by the luminance intra TP motion prediction/compensation unit 122 and color difference intra TP motion prediction/compensation unit 123, a prediction image generated by the motion prediction/compensation unit 124, or a prediction image generated by the luminance inter TP motion prediction/compensation unit 125 and color difference inter TP motion prediction/compensation unit 126, is supplied to the switch 127.

In step S139, the switch 127 selects a prediction image. That is to say, a prediction image generated by the intra prediction unit 121, a prediction image generated by the luminance intra TP motion prediction/compensation unit 122 and color difference intra TP motion prediction/compensation unit 123, a prediction image generated by the motion prediction/compensation unit 124, or a prediction image generated by the luminance inter TP motion prediction/compensation unit 125 and color difference inter TP motion prediction/compensation unit 126, is supplied to the switch 127. A supplied prediction image is selected and supplied to the computing unit 115, and added to the output of the inverse orthogonal transform unit 114 in step S134 as described above.

In step S140, the screen rearranging buffer 117 performs rearranging. That is to say, the order for frames rearranged for encoding by the screen rearranging buffer 62 of the image encoding device 51 in FIG. 1 is rearranged in the original display order.

In step S141, the D/A converter 118 performs D/A conversion of the image from the inverse orthogonal transform screen rearranging buffer 117. This image is output to an unshown display, and the image is displayed.

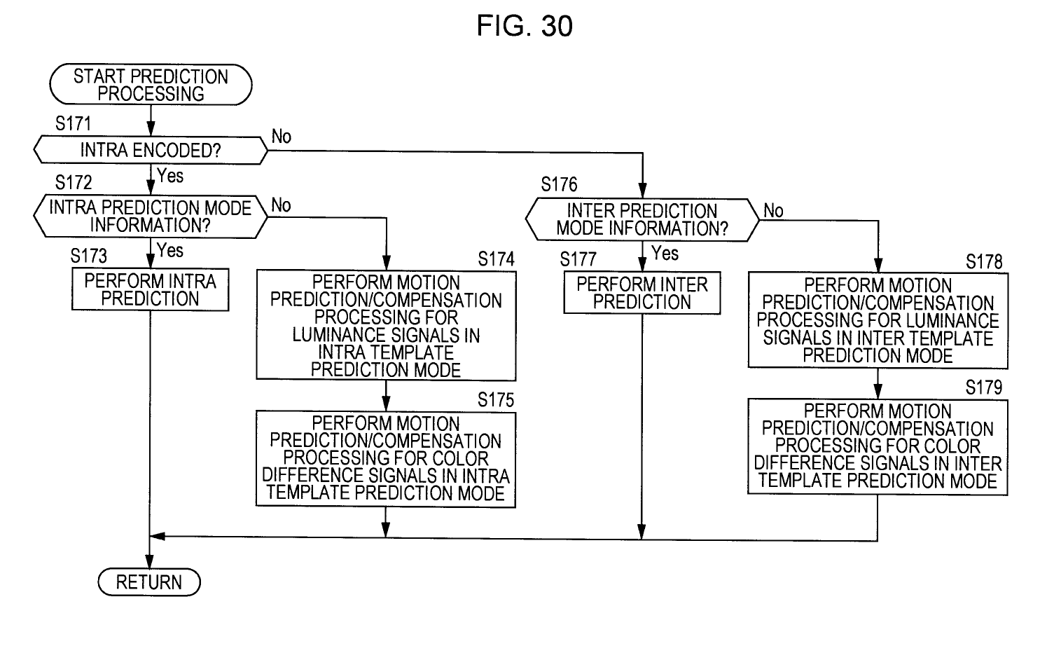

Next, the prediction processing of step S138 in FIG. 29 will be described with reference to FIG. 30.

In step S171, the intra prediction unit 121 determines whether or not the object block has been subjected to intra encoding. In the event that intra prediction mode information or intra template prediction mode information is supplied from the lossless decoding unit 112 to the intra prediction unit 121, the intra prediction unit 121 determines in step S171 that the object block has been subjected to intra encoding, and in step S172 determines whether or not the prediction mode information from the lossless decoding unit 112 is intra prediction mode information.

In step S172, in the event that the intra prediction unit 121 determines that this is intra prediction mode information, in step S173, intra prediction is performed.

That is to say, in the event that the image to be processed is an image to be subjected to intra processing, a necessary image is read out from the frame memory 119 and supplied to the intra prediction unit 121 via the switch 120. In step S173, the intra prediction unit 121 performs intra prediction following the intra prediction mode information supplied from the lossless decoding unit 112, and generates a prediction image.

In the event that determination is made in step S172 that this is not intra prediction mode information, the flow advances to step S174, and intra template prediction mode processing is performed.

In the event that the image to be processed is an image to be subjected to inter template prediction processing, a necessary image is read out from the frame memory 119, and is supplied to the luminance intra TP motion prediction/compensation unit 122 via the switch 120 and intra prediction unit 121. In step S174, the luminance intra TP motion prediction/compensation unit 122 performs intra template motion prediction processing of the luminance signals in the intra template prediction mode, based on the image read out from the frame memory 119.

That is to say, in step S174, the luminance intra TP motion prediction/compensation unit 122 searches for an intra motion vector for the luminance signals, based on the intra template matching method, and generates a prediction image of the luminance signals based on the motion vector.

The luminance intra TP motion prediction/compensation unit 122 supplies the image for intra prediction that has been read out from the frame memory 119 and the motion vector information found in the motion prediction and compensation processing for luminance signals to the color difference intra TP motion prediction/compensation unit 123.

Accordingly, in step S175, the color difference intra TP motion prediction/compensation unit 123 performs motion prediction and compensation processing for color difference signals in the intra template prediction mode, based on the image for intra prediction that has been read out from the frame memory 119, and generates a prediction image for the color difference signals. At this time, the color difference intra TP motion prediction/compensation unit 123 obtains a center of searching using the motion vector information found by the luminance intra TP motion prediction/compensation unit 122, and performs motion prediction in the predetermined search range with this as the center of searching.

The prediction image generated by the color difference signals intra template prediction mode motion prediction/compensation processing is supplied to the luminance intra TP motion prediction/compensation unit 122. The prediction image generated by luminance and color difference intra template prediction mode motion prediction/compensation processing is supplied to the intra prediction unit 121.

Note that the processing of steps S174 and S175 basically perform the same processing as with steps S61 and S62 in FIG. 21 described above, so detailed description thereof will be omitted.

On the other hand, in the event that determination is made in step S171 that the object block has not been subjected to intra encoding, the processing advances to step S176.

In the event that the image to be processed is an image to be subjected to inter processing, inter prediction mode information, reference frame information, and motion vector information are supplied to the intra prediction unit 121. In step S176, the motion prediction/compensation unit 124 determines whether or not the prediction mode information from the lossless decoding unit 112 is inter prediction mode information, and in the event that determination is made that this is inter prediction mode information, in step S177 inter motion prediction is performed.

In the event that the image to be processed is an image to be subjected to inter prediction processing, a necessary image is read out from the frame memory 119, and is supplied to the motion prediction/compensation unit 124 via the switch 120. In step S174, the motion prediction/compensation unit 124 performs inter prediction mode motion prediction based on the motion vector supplied from the lossless decoding unit 112, and generates a prediction image.

In the event that determination is made in step S176 that this is not inter prediction mod information, i.e., that this is inter template prediction mode information, the processing advances to step S178, and inter template prediction mode processing is performed.

In the event that the image to be processed is an image to be subjected to inter template prediction processing, a necessary image is read out from the frame memory 119, and is supplied to the luminance inter TP motion prediction/compensation unit 125 via the switch 120 and motion prediction/compensation unit 124. In step S178, the luminance inter TP motion prediction/compensation unit 125 performs luminance signal inter template motion prediction processing in the inter template prediction mode, based on the image read out from the frame memory 119.

That is to say, in step S178, the luminance inter TP motion prediction/compensation unit 125 searches for a luminance signal inter motion vector based on the inter template matching method, and generates a prediction image of the luminance signals based on the motion vector.

The luminance inter TP motion prediction/compensation unit 125 supplies the image for inter prediction read out from the frame memory 119, and the motion vector information found in the luminance signal motion prediction and compensation processing to the color difference inter TP motion prediction/compensation unit 126.

Accordingly, the color difference inter TP motion prediction/compensation unit 126 performs color difference signal motion prediction and compensation processing in the inter template prediction mode, based on the image for inter prediction read out from the frame memory 119, and generates a color difference signal prediction image. At this time, the color difference inter TP motion prediction/compensation unit 126 obtains the center of searching using the motion vector information found by the luminance inter TP motion prediction/compensation unit 125, and performs motion prediction in the predetermined search range with this as the center of searching.

The prediction image generated by the motion prediction/compensation processing in the color difference inter template prediction mode is supplied to the luminance inter TP motion prediction/compensation unit 125. The prediction image generated by the luminance and color difference inter template prediction mode motion prediction/compensation processing is supplied to the motion prediction/compensation unit 124.

Note that the processing in these steps S178 and S179 basically perform the same processing as with steps S71 and S72 in FIG. 25 described above, so detailed description thereof will be omitted.

As described above, with an image encoding device and image decoding device, motion prediction is performed based on template matching where motion searching is performed using a decoded image, so good image quality can be displayed without sending motion vector information.

Also, at this time, motion prediction of color difference signals is performed separately from motion prediction of luminance signals, so compression efficiency can be improved.

Further, at the time of performing motion prediction of color difference signals, searching is performed around motion vector information found by motion prediction of luminance signals, so the amount of computation necessary for motion vector searching can be reduced.

Also, at the time of performing motion prediction/compensation processing with the H.264/AVC format, prediction based on template matching is also performed, and the one with a better cost function value is selected to perform encoding processing with, whereby encoding efficiency can be improved.

Now, let us consider applying the above-described intra or inter template matching to color difference signals in 4×4 pixel increment blocks.

As described above with reference to FIG. 6, with color difference signals a macro block is divided into 4×4 pixels and 4×4 pixel DCT is performed. After the 4×4 pixel DCT is performed, the direct current component of each of the blocks is gathered and a 2×2 pixel block is generated as with blocks 16 and 17, which is further subjected to orthogonal transform.

That is, due to the orthogonal transform of the direct current component shown in the block 16, the pixel values of the decoded image as to the block 18 are not identified when processing the block 19. Accordingly, in actual practice, at the time of processing color difference signals in 4×4 pixel increment blocks, template matching processing using adjacent pixels cannot be performed.

Accordingly, with the image encoding device shown in FIG. 31, orthogonal transform as to direct current component is controlled at the time of performing template matching. Note that in the following, direct current component will also be referred to as DC component, as appropriate.

FIG. 31 represents the configuration of another embodiment of an image encoding device serving as an image processing device to which the present invention has been applied.

The image encoding device 151 in FIG. 31 is configured of an A/D converter 61, a screen rearranging buffer 62, a computing unit 63, an orthogonal transform unit 64, a quantization unit 65, a lossless encoding unit 66, an accumulation buffer 67, an inverse quantization unit 68, an inverse orthogonal transform unit 69, a computing unit 70, a deblocking filter 71, frame memory 72, a switch 73, an intra prediction unit 74, a motion prediction/compensation unit 77, a prediction image selecting unit 80, a rate control unit 81, an intra template motion prediction/compensation unit 161, an inter template motion prediction/compensation unit 162, and an orthogonal transform control unit 163.

Though omitted from the drawing, the intra template motion prediction/compensation unit 161 is configured of the luminance intra TP motion prediction/compensation unit 75 and color difference intra TP motion prediction/compensation unit 76 shown in FIG. 1. Also, the inter template motion prediction/compensation unit 162 is configured of the luminance inter TP motion prediction/compensation unit 78 and color difference inter TP motion prediction/compensation unit 79 in FIG. 1.

That is to say, the image encoding device 151 in FIG. 31 differs from the image encoding device 51 in FIG. 1 in that the orthogonal transform control unit 163 has been added, but other points are basically the same configuration as with the image encoding device 51 in FIG. 1.

The intra template motion prediction/compensation unit 161 performs motion prediction/compensation processing of luminance signals and color difference signals in the intra template prediction mode, in the same way as with the luminance intra TP motion prediction/compensation unit 75 and color difference intra TP motion prediction/compensation unit 76 in FIG. 1. At this time, the intra template motion prediction/compensation unit 161 outputs information of the object block on which the template matching is to be performed, to the orthogonal transform control unit 163.

The inter template motion prediction/compensation unit 162 performs motion detection and compensation processing of luminance signals and color difference signals in the inter template prediction mode, in the same way as with the luminance inter TP motion prediction/compensation unit 78 and color difference inter TP motion prediction/compensation unit 79 in FIG. 1. At this time, the inter template motion prediction/compensation unit 162 outputs information of the object block on which the template matching is to be performed, to the orthogonal transform control unit 163.

Information of the object block on which the template matching is to be performed is input to the orthogonal transform control unit 163 from the intra template motion prediction/compensation unit 161 or the inter template motion prediction/compensation unit 162.

The orthogonal transform control unit 163 performs orthogonal transform control processing in the template prediction mode. That is to say, the orthogonal transform control unit 163 performs a first determination regarding whether or not the object block on which the template matching is to be performed relates to color difference signals, and performs a second determination regarding whether or not the object block on which the template matching is to be performed is a macro block. The orthogonal transform control unit 163 then controls the orthogonal transform unit 64 and inverse orthogonal transform unit 69 in accordance with the first determination results and second determination results.

For example, in the event that the object block relates to color difference signals and is not a macro block, the orthogonal transform unit 64 and inverse orthogonal transform unit 69 are controlled such that each of orthogonal transform and inverse orthogonal transform as to the direct current component of each block is forbidden.

In the event that the object block relates to color difference signals and is a macro block, the orthogonal transform unit 64 and inverse orthogonal transform unit 69 are controlled such that each of orthogonal transform and inverse orthogonal transform as to the direct current component of each block is performed.

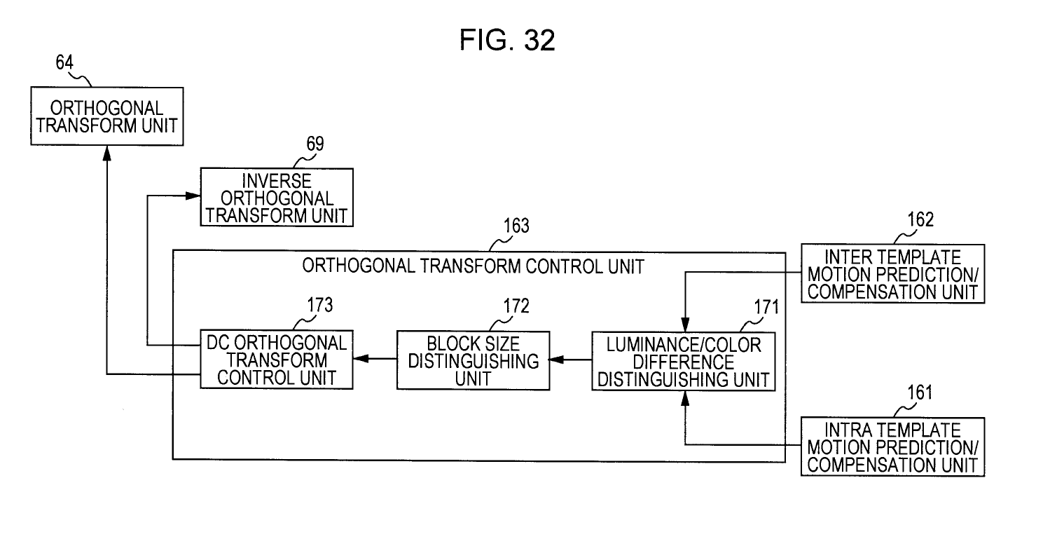

FIG. 32 illustrates a configuration example of the orthogonal transform control unit.

In FIG. 32, the orthogonal transform control unit 163 is configured of a luminance/color difference distinguishing unit 171, a block size distinguishing unit 172, and a DC orthogonal transform control unit 173.

Information of an object block on which template matching is to be performed, is supplied to the luminance/color difference distinguishing unit 171 from the intra template motion prediction/compensation unit 161 or inter template motion prediction/compensation unit 162. For example, information indicating that the object block relates to luminance signals or to color difference signals, block size information of the object block, direct current component information of the object block, and so forth, is supplied as object block information.

Based on these information, the luminance/color difference distinguishing unit 171 determines whether or not the block on which template matching is to be performed relates to color difference signals. Only in the event that the block on which template matching is to be performed relates to color difference signals does the luminance/color difference distinguishing unit 171 supply object block information to the block size distinguishing unit 172.

That is to say, in the event that the block on which template matching is to be performed relates to luminance signals, orthogonal transform control by the DC orthogonal transform control unit 173 is not performed.

The block size distinguishing unit 172 determines whether or not the object block on which template matching is to be performed is a macro block. In the event that the object block on which template matching is to be performed is a macro block, the block size distinguishing unit 172 supplies object block information to the DC orthogonal transform control unit 173.

Accordingly, the DC orthogonal transform control unit 173 transmits information of the direct current (DC) component of the object block to the orthogonal transform unit 64 and inverse orthogonal transform unit 69, so that orthogonal transform and inverse orthogonal transform is each performed as to the direct current component of each block.

In the event that the object block on which template matching is to be performed is not a macro block, the block size distinguishing unit 172 does not supply object block information to the DC orthogonal transform control unit 173, so as to forbid processing of the orthogonal transform unit 64 and inverse orthogonal transform unit 69 on the direct current component.

Accordingly, processing is not performed at the orthogonal transform unit 64 and inverse orthogonal transform unit 69 as to the direct current component of each block.

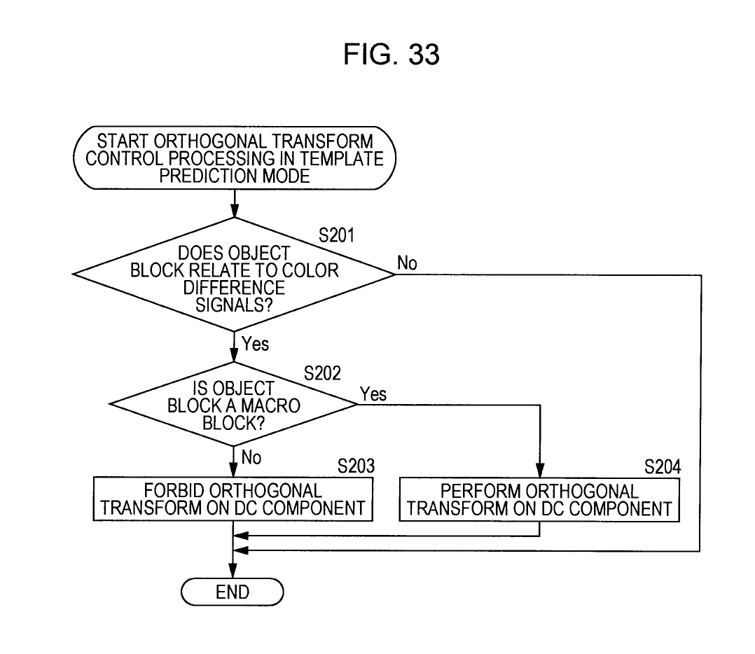

Next, orthogonal transform control processing in the template prediction mode will be described with reference to the flowchart in FIG. 33. This processing is processing performed at the orthogonal transform control unit 163 at the time of intra template prediction mode luminance signal processing in step S61 and color difference signal processing in step S62 in FIG. 21. Also, this processing is processing performed at the orthogonal transform control unit 163 at the time of inter template prediction mode luminance signal processing in step S61 and color difference signal processing in step S62 in FIG. 25.

Information of the object block on which template matching is to be performed is input to the luminance/color difference distinguishing unit 171 from the intra template motion prediction/compensation unit 161 or the inter template motion prediction/compensation unit 162. In step S201, the luminance/color difference distinguishing unit 171 determines whether or not the object block on which template matching is to be performed relates to color difference signals, based on the supplied object block information.

In the event that determination is made in step S201 that the object block on which template matching is to be performed relates to color difference signals, the processing advances to step S202. At this time, the luminance/color difference distinguishing unit 171 supplies the object block information to the block size distinguishing unit 172.

In step S202, the block size distinguishing unit 172 determines whether or not the object block on which template matching is to be performed is a macro block. In the event that determination is made in step S202 that the object block on which template matching is to be performed is not a macro block, the processing advances to step S203.

The block size distinguishing unit 172 does not supply object block information to the DC orthogonal transform control unit 173, and in step S203, the orthogonal transform unit 64 and inverse orthogonal transform unit 69 are each forbidden to perform orthogonal transform and inverse orthogonal transform on the direct current component of each block.

Accordingly, in step S14 in FIG. 4 described above, the orthogonal transform unit 64 does not perform orthogonal transform on the direct current component of the object block, and in step S17, the inverse orthogonal transform unit 69 does not perform inverse orthogonal transform on the direct current component of the object block.

Accordingly, even in cases of being color difference signals and the object block not being a macro block, the intra template motion prediction/compensation unit 161 or inter template motion prediction/compensation unit 162 can perform template prediction mode processing using adjacent pixels.

Also, in step S202, in the event that determination is made that the object block on which template matching is to be performed is a macro block, the processing advances to step S204. At this time, the block size distinguishing unit 172 supplies the object block information to the DC orthogonal transform control unit 173. In step S204, the DC orthogonal transform control unit 173 transmits the direct current (DC) component information of the object block to the orthogonal transform unit 64 and the inverse orthogonal transform unit 69, so that orthogonal transform and inverse orthogonal transform are performed on the direct current component of each block.

Accordingly, in step S14 in FIG. 4 described above, the orthogonal transform unit 64 performs orthogonal transform on the direct current component of the object block, and in step S17, the inverse orthogonal transform unit 69 performs inverse orthogonal transform on the direct current component of the object block.

In the event that determination is made in step S201 that the object block on which template matching is to be performed relates to luminance signals, the orthogonal transform control processing in the template prediction mode ends. That is to say, in the event that the object block relates to luminance signals as well, orthogonal transform and inverse orthogonal transform are not performed on the direct current component of each block.

However, in the case of luminance signals, separately from this processing, the orthogonal transform unit 64 and inverse orthogonal transform unit 69 each perform orthogonal transform on the direct current component of each block only when in the 16×16 pixel intra prediction mode, as described earlier with reference to FIG. 6.

The orthogonal transform control processing in the template prediction mode is also executed at the image decoding device shown in FIG. 32.

FIG. 32 illustrates another embodiment of an image decoding device serving as an image processing device to which the present invention has been applied.

The image decoding device 201 in FIG. 32 is configured of an accumulation buffer 111, a lossless decoding unit 112, an inverse quantization unit 113, an inverse orthogonal transform unit 114, a computing unit 115, a deblocking filter 116, a screen rearranging buffer 117, a D/A converter 118, frame memory 119, a switch 120, an intra prediction unit 121, a motion prediction/compensation unit 124, a switch 127, an intra template motion prediction/compensation unit 211, an inter template motion prediction/compensation unit 212, and an orthogonal transform control unit 213.

While omitted from the drawing, the intra template motion prediction/compensation unit 211 is configured of the luminance intra TP motion prediction/compensation unit 122 and color difference intra TP motion prediction/compensation unit 123 in FIG. 28. Also, the inter template motion prediction/compensation unit 212 is configured of the luminance inter TP motion prediction/compensation unit 125 and color difference inter TP motion prediction/compensation unit 126 in FIG. 28.

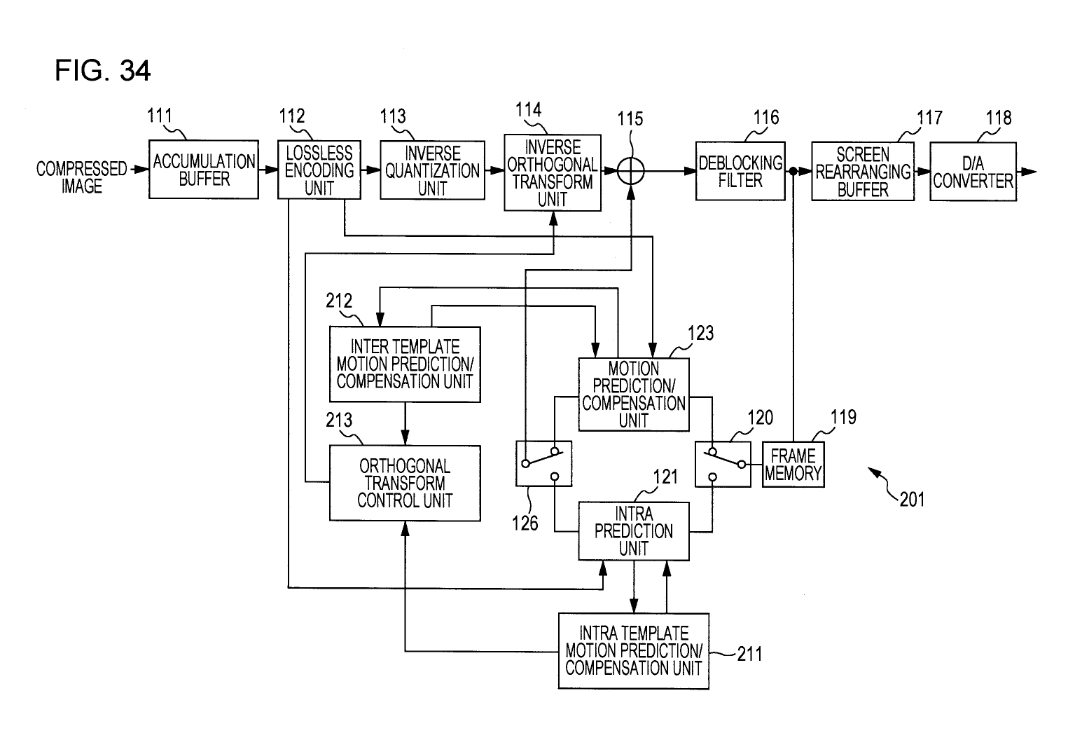

That is to say, the image decoding device 201 in FIG. 34 differs from the image decoding device 101 in FIG. 28 with regard to the point that the orthogonal transform control unit 213 has been added but other points are basically of the same configuration as the image decoding device in FIG. 28.

The intra template motion prediction/compensation unit 211 performs motion prediction and compensation processing of luminance signals and color difference signals in the intra template prediction mode, in the same way as with the luminance intra TP motion prediction/compensation unit 122 and color difference intra TP motion prediction/compensation unit 123 in FIG. 28. At this time, the intra template motion prediction/compensation unit 211 outputs information of the object block on which template matching is to be performed to the orthogonal transform control unit 213.

The inter template motion prediction/compensation unit 212 performs motion prediction and compensation processing of luminance signals and color difference signals in the inter template prediction mode, in the same way as with the luminance inter TP motion prediction/compensation unit 125 and color difference inter TP motion prediction/compensation unit 126 in FIG. 28. At this time, the inter template motion prediction/compensation unit 212 outputs information of the object block on which template matching is to be performed to the orthogonal transform control unit 213.

Information of the object block on which template matching is to be performed is supplied from the intra template motion prediction/compensation unit 211 or the inter template motion prediction/compensation unit 212 to the orthogonal transform control unit 213.

In the same way as with the orthogonal transform control unit 163 in FIG. 31, the orthogonal transform control unit 213 performs orthogonal transform control processing in the template prediction mode. That is to say, the orthogonal transform control unit 213 performs a first determination regarding whether or not the object block on which the template matching is to be performed relates to color difference signals, and performs a second determination regarding whether or not the object block on which the template matching is to be performed is a macro block. The orthogonal transform control unit 213 then controls the inverse orthogonal transform unit 114 in accordance with the first determination results and the second determination results.

For example, in the event that the object block relates to color difference signals and is not a macro block, the inverse orthogonal transform unit 114 is controlled so as to forbid inverse orthogonal transform to the direct current component of each block.

In the event that the object block relates to color difference signals and is a macro block, the inverse orthogonal transform unit 114 is controlled so as to perform inverse orthogonal transform on the direct current component of each block.

The orthogonal transform control unit 213 is basically configured the same as the orthogonal transform control unit 163 in FIG. 31, so the configuration example of the orthogonal transform control unit 163 in FIG. 32 will be used for the following description of the orthogonal transform control unit 213 as well.

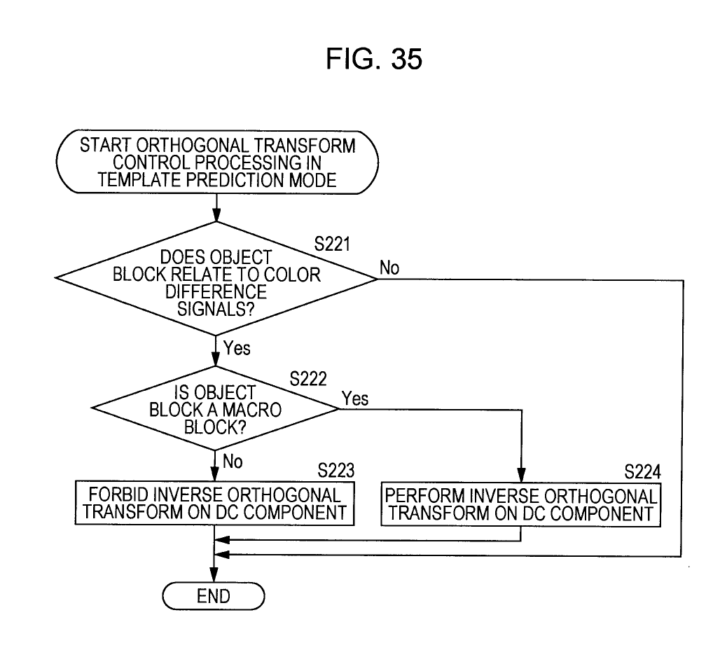

Next, orthogonal transform control processing in the template prediction mode will be described with reference to the flowchart in FIG. 35. This processing is processing performed at the orthogonal transform control unit 213 at the time of processing of luminance signals in the intra template prediction mode in step S174 in FIG. 30, and processing of color difference signals in the intra template prediction mode in step S175. Also, this processing is processing performed at the orthogonal transform control unit 213 at the time of processing of luminance signals in the inter template prediction mode in step S178 in FIG. 30, and processing of color difference signals in step S179.

Information of the object block on which template matching is to be performed is input to the luminance/color difference distinguishing unit 171 from the intra template motion prediction/compensation unit 211 or the inter template motion prediction/compensation unit 212. In step S221, the luminance/color difference distinguishing unit 171 determines whether or not the object block on which template matching is to be performed relates to color difference signals, based on the supplied object block information.

In the event that determination is made in step S221 that the object block on which template matching is to be performed relates to color difference signals, the processing advances to step S222. At this time, the luminance/color difference distinguishing unit 171 supplies the object block information to the block size distinguishing unit 172.

In step S222, the block size distinguishing unit 172 determines whether or not the object block on which template matching is to be performed is a macro block. In the event that determination is made in step S222 that the object block on which template matching is to be performed is not a macro block, the processing advances to step S223.

The block size distinguishing unit 172 does not supply object block information to the DC orthogonal transform control unit 173, and in step S223, the inverse orthogonal transform unit 114 is forbidden to perform inverse orthogonal transform on the direct current component of each block.

Accordingly, in step S134 in FIG. 29 described above, the inverse orthogonal transform unit 114 does not perform inverse orthogonal transform on the direct current component of the object block.

Accordingly, even in cases of being color difference signals and the object block not being a macro block, the intra template motion prediction/compensation unit 211 or inter template motion prediction/compensation unit 212 can perform template prediction mode processing using adjacent pixels.

Also, in step S222, in the event that determination is made that the object block on which template matching is to be performed is a macro block, the processing advances to step S224. At this time, the block size distinguishing unit 172 supplies the object block information to the DC orthogonal transform control unit 173. In step S224, the DC orthogonal transform control unit 173 transmits the direct current (DC) component information of the object block to the inverse orthogonal transform unit 114, so that inverse orthogonal transform is performed on the direct current component of each block.

Accordingly, in step S134 in FIG. 29 described above, the inverse orthogonal transform unit 114 performs inverse orthogonal transform on the direct current component of the object block.

On the other hand, in the event that determination is made in step S221 that the object block on which template matching is to be performed relates to luminance signals, the orthogonal transform control processing in the template prediction mode ends.

However, with the image decoding device as well, in the case of luminance signals, separately from this processing, inverse orthogonal transform unit 114 performs inverse orthogonal transform on the direct current component of each block only when in the 16×16 pixel intra prediction mode, as described earlier with reference to FIG. 6.

This, in cases of being color difference signals and the object block not being a macro block, orthogonal transform and inverse orthogonal transform is not performed on direct current components, so template prediction mode processing using adjacent pixels can be performed.

Note that while description has been made above with an example of a chroma format of 4:2:0, the present invention can also be applied to cases or 4:2:2 or 4:4:4.

Also, while description has been made using the H.264/AVC format as an encoding format, other encoding formats/decoding formats may be used.

Note that the present invention may be applied to image encoding devices and image decoding devices at the time of receiving image information (bitstream) compressed by orthogonal transform and motion compensation such as discrete cosine transform or the like, as with MPEG, H.26x, or the like for example, via network media such as satellite broadcasting, cable TV (television), the Internet, and cellular telephones or the like, or at the time of processing on storage media such as optical or magnetic discs, flash memory, and so forth.

The above-described series of processing may be executed by hardware, or may be executed by software. In the event that the series of processing is to be executed by software, the program making up the software is installed from a program recording medium to a computer built into dedicated hardware, or a general-purpose personal computer capable of executing various types of functions by installing various types of programs, for example.

The program recording media for storing the program which is to be installed to the computer so as to be in a computer-executable state, is configured of removable media which is packaged media such as magnetic disks (including flexible disks), optical discs (including CD-ROM (Compact Disc-Read Only Memory), DVD (Digital Versatile Disc), and magneto-optical discs), or semiconductor memory or the like, or, ROM or hard disks or the like where programs are temporarily or permanently stored. Storing of programs to the recording media is performed using cable or wireless communication media such as local area networks, the Internet, digital satellite broadcasting, and so forth, via interfaces such as routers, modems, and so forth, as necessary.

Note that the steps describing the program in the present specification include processing being performed in the time-sequence of the described order as a matter of course, but also include processing being executed in parallel or individually, not necessarily in time-sequence.

Also note that the embodiments of the present invention are not restricted to the above-described embodiments, and that various modifications may be made without departing from the essence of the present invention.

### REFERENCE SIGNS LIST

51 image encoding device
66 lossless encoding unit
74 intra prediction unit
75 luminance intra TP motion prediction/compensation unit
76 color difference intra TP motion prediction/compensation unit
77 motion prediction/compensation unit
78 luminance inter TP motion prediction/compensation unit
79 color difference inter TP motion prediction/compensation unit
80 predicted image selecting unit
101 image decoding device
112 lossless decoding unit
121 intra prediction unit
122 luminance intra TP motion prediction/compensation unit
123 color difference intra TP motion prediction/compensation unit
124 motion prediction/compensation unit
125 luminance inter TP motion prediction/compensation unit
126 color difference inter TP motion prediction/compensation unit
127 switch
151 image encoding device
161 intra template motion prediction/compensation unit
162 inter template motion prediction/compensation unit
163 orthogonal transform control unit
201 image decoding device
211 intra template motion prediction/compensation unit
212 inter template motion prediction/compensation unit
213 orthogonal transform control unit

1. An image processing device comprising:
luminance motion prediction compensation means to search for a motion vector of a luminance block, which is a block of luminance signals of a frame, using a first template which is adjacent to said luminance block with a predetermined positional relation and also is generated from a decoded image;
color difference motion prediction compensation means to obtain a search range using information of the motion vector of said luminance block searched by said luminance motion prediction compensation means, and to, within said search range that has been obtained, search for a motion vector of a color difference block which is a block of color difference signals of said frame, corresponding to said luminance block, using a second template which is adjacent to said color difference block with a predetermined positional relation and also is generated from said decoded image; and
encoding means to encode an image of said luminance block and said color difference block.

2. The processing device according to claim 1, wherein said color difference motion prediction compensation means perform scaling of information of the motion vector of said luminance block searched by said luminance motion prediction compensation means, in accordance with a chroma format of input image signals, and obtain said search range centered on information of the motion vector of said luminance block that has been scaled.

3. The processing device according to claim 2, wherein, in the event that said luminance block and said color difference block are in a one-on-one correlating relation, information of the motion vector of said luminance block is (MVTMₕ, MVTMᵥ) and rₕ and rᵥ are defined as
$$[ Mathematical Expression 20 ]$$
$${r}_{h} = \{ \begin{matrix}2 ( Case of 4 \text{:} 2 \text{:} 0 ) \\ 2 ( Case of 4 \text{:} 2 \text{:} 2 ) \\ 1 ( Case of 4 \text{:} 4 \text{:} 4 )\end{matrix} \\ {r}_{v} = \{ \begin{matrix}2 ( Case of 4 \text{:} 2 \text{:} 0 ) \\ 1 ( Case of 4 \text{:} 2 \text{:} 2 ) \\ 1 ( Case of 4 \text{:} 4 \text{:} 4 )\end{matrix}$$
said color difference motion prediction compensation means obtain said search range centered on (MVTMₕ/rₕ, MVTMᵥ/rᵥ).

4. The processing device according to claim 2, wherein, in the event that a single said color difference block corresponds to a plurality of said luminance blocks, said color difference motion prediction compensation means synthesize information of motion vectors of a plurality of said luminance blocks, perform scaling in accordance with said chroma format, and obtain said search range centered on information of the motion vector of said luminance block that has been scaled.

5. The processing device according to claim 4, wherein said color difference motion prediction compensation means perform synthesizing using the average value of the information of motion vectors of the plurality of said luminance blocks.

6. The processing device according to claim 2, wherein said color difference motion prediction compensation means obtain said search range regarding only a reference frame of said luminance block, and search for a motion vector of said color difference block in said search range that has been obtained, using said second template.

7. The processing device according to claim 2, wherein said color difference motion prediction compensation means obtain said search range regarding only a reference frame having, of reference frames of said luminance block, a smallest index, and search for a motion vector of said color difference block in said search range that has been obtained, using said second template.

8. The processing device according to claim 2, wherein the size of said luminance block and said color difference block differ;
and wherein the size of said first template and the size of said second template differ.

9. The processing device according to claim 2, further comprising orthogonal transform control means to forbid, in the event that a motion prediction regarding which motion prediction is to be performed is said color difference block and is not a macro block, orthogonal transform as to a direct current component of said motion prediction block.

10. An image processing method, comprising the steps of an image processing device:
searching for a motion vector of a luminance block, which is a block of luminance signals of a frame, using a first template which is adjacent to said luminance block with a predetermined positional relation and also is generated from a decoded image;
obtaining a search range using information of the motion vector of said luminance block searched by said luminance motion prediction compensation means, and, within said search range that has been obtained, searching for a motion vector of a color difference block which is a block of color difference signals of said frame, corresponding to said luminance block, using a second template which is adjacent to said color difference block with a predetermined positional relation and also is generated from said decoded image; and
encoding an image of said luminance block and said color difference block.

11. An image processing device comprising:
decoding means to decode an image, which is a luminance block which is a block of luminance signals and a color difference block which is a block of color difference signals and which corresponds to said luminance block, of an encoded frame;
luminance motion prediction compensation means to search for a motion vector of said luminance block, using a first template which is adjacent to said luminance block with a predetermined positional relation and also is generated from a decoded image; and
color difference motion prediction compensation means to obtain a search range using information of the motion vector of said luminance block searched by said luminance motion prediction compensation means, and to, within said search range that has been obtained, search for a motion vector of said color difference block, using a second template which is adjacent to said color difference block with a predetermined positional relation and also is generated from said decoded image.

12. The processing device according to claim 11, wherein said color difference motion prediction compensation means perform scaling of information of the motion vector of said luminance block searched by said luminance motion prediction compensation means, in accordance with a chroma format of input image signals, and obtain said search range centered on information of the motion vector of said luminance block that has been scaled.

13. The processing device according to claim 12, wherein, in the event that said luminance block and said color difference block are in a one-on-one correlating relation, information of the motion vector of said luminance block is (MVTMₕ, MVTMᵥ) and rₕ and rᵥ are defined as
$$[ Mathematical Expression 21 ]$$
$${r}_{h} = \{ \begin{matrix}2 ( Case of 4 \text{:} 2 \text{:} 0 ) \\ 2 ( Case of 4 \text{:} 2 \text{:} 2 ) \\ 1 ( Case of 4 \text{:} 4 \text{:} 4 )\end{matrix} \\ {r}_{v} = \{ \begin{matrix}2 ( Case of 4 \text{:} 2 \text{:} 0 ) \\ 1 ( Case of 4 \text{:} 2 \text{:} 2 ) \\ 1 ( Case of 4 \text{:} 4 \text{:} 4 )\end{matrix}$$
said color difference motion prediction compensation means obtain said search range centered on (MVTMₕ/rₕ, MVTMᵥ/rᵥ).

14. The processing device according to claim 12, wherein, in the event that a single said color difference block corresponds to a plurality of said luminance blocks, said color difference motion prediction compensation means synthesize information of motion vectors of a plurality of said luminance blocks, perform scaling in accordance with said chroma format, and obtain said search range centered on information of the motion vector of said luminance block that has been scaled.

15. The processing device according to claim 14, wherein said color difference motion prediction compensation means perform synthesizing using the average value of the information of motion vectors of the plurality of said luminance blocks.

16. The processing device according to claim 12, wherein said color difference motion prediction compensation means obtain said search range regarding only a reference frame of said luminance block, and search for a motion vector of said color difference block in said search range that has been obtained, using said second template.

17. The processing device according to claim 12, wherein said color difference motion prediction compensation means obtain said search range regarding only a reference frame having, of reference frames of said luminance block, a smallest index, and search for a motion vector of said color difference block in said search range that has been obtained, using said second template.

18. The processing device according to claim 12, wherein the size of said luminance block and said color difference block differ;
and wherein the size of said first template and the size of said second template differ.

19. The processing device according to claim 12, further comprising orthogonal transform control means to forbid, in the event that a motion prediction regarding which motion prediction is to be performed is said color difference block and is not a macro block, orthogonal transform as to a direct current component of said motion prediction block.

20. An image processing method comprising the steps of an image processing device:
decoding an image, which is a luminance block which is a block of luminance signals and a color difference block which is a block of color difference signals and which corresponds to said luminance block, of an encoded frame;
searching for a motion vector of said luminance block, using a first template which is adjacent to said luminance block with a predetermined positional relation and also is generated from a decoded image; and
obtaining a search range using information of the motion vector of said luminance block searched by said luminance motion prediction compensation means, and, within said search range that has been obtained, searching for a motion vector of said color difference block, using a second template which is adjacent to said color difference block with a predetermined positional relation and also is generated from said decoded image.
